(19) United States
(12) Patent Application Publication
(10) Pub. No.: US 2010/0239749 A1
(43) Pub. Date: Sep. 23, 2010

(54) Electronic circuit board manufacturing method

(75) Inventors: Junichi Yoshida, Kanagawa-ken (JP); Seiichi Inoue, Kanagawa-ken (JP); Wataru Ono, Fujinomiya-shi (JP); Hiroshi Kawakami, Fujinomiya-shi (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/659,720

(22) Filed: Mar. 18, 2010

(30) Foreign Application Priority Data
Mar. 19, 2009 (JP) 2009-068513
Jul. 23, 2009 (JP) 2009-172024

(51) Int. Cl. B05D 5/12

(52) U.S. Cl. 427/97.3; 427/98.4

(57) ABSTRACT

An electronic circuit board is formed by a pattern forming step for forming a conductive pattern of an electronic circuit board by applying a metal colloid solution on a base material by an inkjet method and a coagulant application step for applying a coagulant solution at least on the conductive pattern by a deposition method.

### BACKGROUND OF THE INVENTION

1. Field of the Invention

The present invention relates to an electronic circuit board manufacturing method, and more particularly to an electronic circuit board manufacturing method for forming a wiring of an electronic circuit board.

2. Description of the Related Art

Heretofore, as methods for forming a pattern of a wiring portion (conductor portion) of an electronic circuit board (printed wiring board), subtractive method, semi-additive method, and additive method are known.

The subtractive method is a method for forming a pattern of conductor portion (wiring pattern) by removing an unnecessary portion of a metal layer formed on a base material while leaving a necessary portion. In contrast, the semi-additive or additive method is a method for additively forming a pattern of conductor portion on a base material. In each case, the pattern of conductor portion is formed based on a photolithography technology.

The subtractive method, semi-additive method, and additive method will now be described a bit further using FIGS. 7 to 9. Note that each of FIGS. 7 to 9 schematically illustrates a cross-section of a printed wiring board.

FIG. 7 illustrates a process of forming a pattern of conductor portion when the subtractive method is used. In the subtractive method, a conductive layer 202 of copper foil is formed on each side of an insulating base material (insulation layer) 200 to provide a copper clad lamination as shown in Step 1. Then, as shown in Step 2, through-hole (via hole) 206 is made in the copper clad lamination 204 and, as shown in Step 3, conductive metal layer 208 is formed on the surface of each conductive layer 202 and on the inner wall of the through-hole 206 by electroplating or electroless plating, whereby the formation of through-hole 206 is completed.

After though-hole 206 is formed, a resist layer 210 is formed on the surface of conductive metal layer 208 on conductive layer 202 with a dry film resist (DFR), a liquid resist, or the like. Then, patterning is performed on resist layer 210 by exposing the layer to radiant rays from a photo tool (not shown) and developing.

After resist layer 210 is patterned, a portion of conductive layer 202 and a portion of conductive metal layer 208 not covered by resist layer 210 are removed by etching, as shown in Step 5 and, as shown in Step 6, resist layer 210 is removed and a printed wiring board is formed.

FIG. 8 illustrates a process of forming a pattern of conductor portion when the semi-additive method is used. In the semi-additive method, in insulating base material 200 shown in Step 1, though-hole 206 is formed, as shown in Step 2 and a conductive metal layer 208 is formed on each surface of insulating base material 200 and on the inner wall of through-hole 206 by electroless plating, as shown in Step 3.

After conductive metal layer 208 is formed, resist layer 210 is formed with a dry film resist (DFR) or a liquid resist. Then, patterning is performed on resist layer 210 by exposing the layer to radiant rays from a photo tool (not shown) and developing.

After resist layer 210 is patterned, a conductive metal 212 is formed by electroplating with a portion of conductive metal layer 208 not covered by resist layer 210 as the seed layer, as shown in Step 5. Then, as shown in Step 6, resist layer 210 is removed and, as shown in Step 7, conductive metal layer 208 not covered by conductive metal 212 is removed, whereby a printed wiring board is formed.

FIG. 9 illustrates a process of forming a pattern of conductor portion when the additive method is used. In the additive method, in insulating base material (insulation layer) 200 shown in Step 1, though-hole 206 is formed, as shown in Step 2. Then, resist layer 210 is formed with a dry film resist (DFR), a liquid resist, or the like and further resist layer 210 is patterned by exposing the resist to radian rays from a photo tool (not shown) and developing, as shown in Step 3.

After resist layer 210 is formed, conductive metal layer 208 is formed on a portion of insulating base material 200 not covered by resist layer 210 and on the inner wall of through-hole 206 by electroless plating, as shown in Step 4. Finally, resist layer 210 is removed and a printed wiring board is formed, as shown in Step 5.

The method for forming a desired wiring pattern by forming a resist pattern based on the photolithography technology described above requires time for providing a photomask. Further, the method also requires resist exposure and development processing for forming a resist pattern aside from the etching for removing an unnecessary portion of wiring metal. Consequently, formation of a wiring pattern takes time and cost. The method also poses a problem of treating a large amount of waste liquid due to the exposure and development processing. Still further, cracking or detachment may occur in the pattern or otherwise the base material itself is damaged if the type and amount of solvent used, and immersion time are not selected appropriately.

Consequently, a method for forming a pattern of wiring portion of an electronic circuit board based on conductive fine particle dispersed ink drawing has recently been proposed. In the conductive fine particle dispersed ink drawing, a wiring pattern is formed by pattering a liquid-like body (metal colloid solution) which includes a conductive fine particle material (metal colloidal particles) directly on a base material according to a desired wiring pattern using inkjet printing method.

The conductive fine particle dispersed ink drawing method does not require a mask so that it requires a less number of manufacturing steps in comparison with the method that forms a resist pattern by photolithography technology and then forms a desired wiring pattern. Further, the conductive fine particle dispersed ink drawing method does not require the exposure and development step so that the waste liquid treatment is no longer required.

As one of such conductive fine particle dispersed ink drawing methods, a method in which a reception layer is formed on a base material and a metal colloid solution is applied to the reception layer and heat-treated to contact the conductive fine particles included in the metal colloid solution to each other, thereby inducing conductivity is proposed as described, for example, in U.S. Pat. No. 7,356,921.

Another method is also proposed in which, when forming a mesh pattern for electromagnetic shielding by applying a liquid which includes a functional material to a transparent base material by inkjet method, a first ink (e.g., cationic or multivalent metal salt) is discharged on the base material and then a second ink (e.g., anionic) is discharged so as to overlap with the first ink to contact the second ink with the first ink on the base material, thereby forming a conductive mesh pattern as described, for example, in Japanese Unexamined Patent Publication No. 2008-066568.

In the methods described in U.S. Pat. No. 7,356,921 and Japanese Unexamined Patent Publication No. 2008-066568, however, prolonged baking at a high temperature is required in order to induce conductivity in the fine particle materials. Consequently, base materials on which a wiring pattern can be formed are limited to heat resistive materials. In addition, high running and manufacturing costs are required with an inevitable large equipment size for high temperature processing. If a low heat resistive base material is used, then the conductivity of the wiring pattern formed may be reduced due to a low heating temperature. In the method describe in Japanese Unexamined Patent Publication No. 2008-066568, if the first and second inks are not appropriately brought into contact, the two types of inks are not mixed together and a desired electrical property may not be obtained. Further, it is necessary to drop inks such that the first and second inks contact appropriately. Consequently, ink drop control becomes complicated, which makes it difficult to form a complicated conductive pattern.

The present invention has been developed in view of the circumstances described above, and it is an object of the present invention to manufacture an electronic circuit board easily with a low cost.

### SUMMARY OF THE INVENTION

A first electronic circuit board manufacturing method of the present invention is a method, including:

a pattern forming step for forming a conductive pattern of an electronic circuit board by applying a metal colloid solution on a base material by an inkjet method; and

a coagulant application step for applying a coagulant solution at least on the conductive pattern by a deposition method.

As for the “deposition method”, any method may be used as long as it is capable of discharging and applying a coagulant solution on a base material and, for example, an inkjet method, a dispenser method, or the like may be used.

The term “applying a coagulant solution at least on the conductive pattern” as used herein refers to not only the case in which the solution is applied on the entire surface of the conductive pattern but also the case in which the solution is applied on the conductive pattern and an intervening space of the pattern and the case in which the solution is applied on a portion of the conductive pattern.

In the first electronic circuit board manufacturing method of the present invention, an application amount of the coagulant solution may be greater than an application amount of the metal colloid solution.

Further, in the first electronic circuit board manufacturing method of the present invention, an application area of the coagulant solution may be not greater than an application area of the metal colloid solution.

A second electronic circuit board manufacturing method of the present invention is a method, including, when forming a conductive pattern of an electronic circuit board by applying a metal colloid solution on a base material by an inkjet method:
a coagulant solution application step for applying a coagulant solution on the base material; and
a pattern forming step for forming the conductive pattern on the coagulant solution with the metal colloid solution.

In the first and second electronic circuit board manufacturing methods of the present invention, a solvent of the coagulant solution may have compatibility with a solvent of the metal colloid solution.

Further, in the first and second electronic circuit board manufacturing methods of the present invention, the difference in SP (Solubility Parameter) value between the solvent of the metal colloid solution and the solvent of the coagulant solution is in the range from 1 to 15.

Still further, in the first and second electronic circuit board manufacturing methods of the present invention, the base material may be a reception layer-equipped base material having a porous reception layer formed on a surface thereof.

A third electronic circuit board manufacturing method of the present invention is a method, including, when forming a conductive pattern of an electronic circuit board on a reception layer-equipped base material, which is a base material with a porous reception layer having a coagulant provided on a surface of the base material,

a pattern forming step for forming the conductive pattern by applying a metal colloid solution on the reception layer-equipped base material by an inkjet method.

The term “a porous reception layer with a coagulant received on a surface of the base material” as used herein refers to not only the case in which the porous reception layer with a coagulant is completely dried but also the case in which the porous reception layer is half dried or not dried.

In the third electronic circuit board manufacturing method of the present invention, the reception layer-equipped base material may be provided by a solution application step in which a mixed solution of a porous reception layer forming component and a coagulant is applied on the base material.

In this case, the mixed solution may be obtained by adding the coagulant to a reception layer forming solution having the porous reception layer forming component, by adding the porous reception layer forming component to a coagulant solution, or by in-line mixing the reception layer forming solution and the coagulant solution.

Further, in the third electronic circuit board manufacturing method of the present invention, the reception layer-equipped base material may be provided by a reception layer forming coagulant solution application step in which a porous reception layer forming component solution and a coagulant solution are applied on the base material.

In this case, the reception layer forming coagulant solution application step may be a step including a reception layer forming solution application step for applying a reception layer forming solution having the porous reception layer forming component and a coagulant application step for applying the coagulant solution, which is incorporated in the reception layer forming solution application step.

Further, in this case, the reception layer forming solution and coagulant solution may be applied one after another at the same time, or the reception layer forming solution is applied first and then the coagulant solution during or after the drying process of the reception layer forming solution.

According to the first electronic circuit board manufacturing method of the present invention, a coagulant solution is applied by a deposition method at least on a conductive pattern formed with a metal colloid solution.

According to the second electronic circuit board manufacturing method of the present invention, a coagulant solution is applied on a base material and then a conductive pattern is formed on the coagulant solution with a metal colloid solution.

According to the third electronic circuit board manufacturing method of the present invention, a conductive pattern is formed on a reception layer-equipped base material, which is a base material with a porous reception layer having a coagulant provided on a surface of the base material, with a metal colloid solution.

Consequently, the cohesiveness of the metal colloidal particles in the metal colloid solution is enhanced by simply leaving the solution at room temperature without heating due to the presence of the coagulant solution. Since the cohesiveness of the metal colloidal particles is enhanced, the standing time at room temperature may be reduced, resulting in a reduced manufacturing time. Further, since the cohesiveness of the metal colloidal particles is enhanced, a conductive pattern may be formed without spoiling the conductivity. Still further, any heating equipment is required since heating process is not required, whereby the manufacturing cost may be reduced. Further, the base material needs not to have high heat resistivity, which increases the selection freedom of base material and a general purpose base material may be used. Thus, according to the present invention, electronic circuit boards may be manufactured efficiently at a low cost without increasing the size of the manufacturing facilities.

In particular, in the second electronic circuit board manufacturing method of the present invention, an entire base material surface application method, such as a bar coating method may be selected as the application method of the coagulant solution. Consequently, the coating process of coagulant solution may be simplified, resulting in a reduced manufacturing cost. Further, the coagulation action is started immediately after the metal colloid solution is applied on the base material, so that the interference between adjacently applied metal colloid solutions during the application of the metal colloid solution may be prevented.

Further, in the first electronic circuit board manufacturing method of the present invention, the cohesiveness of the metal colloidal particles may be further enhanced by applying the coagulant solution in an amount greater than an application amount of the metal colloid solution and whereby the standing time at room temperature may further be reduced.

Still further, in the first electronic circuit board manufacturing method of the present invention, the consumed amount of coagulant solution may be reduced by limiting the application area of the coagulant solution smaller than the application area of the metal colloid solution. Further, this will result in that the coagulant solution is applied concentratingly only on a required portion, so that the coagulation of the metal colloidal particles may be efficiently enhanced, which may further reduce the standing time at room temperature. Still further, the conductive pattern formed with the metal colloid solution may be prevented from wet-spreading, since the coagulant solution is applied only on a required portion.

Further, in the third electronic circuit board manufacturing method of the present invention, a reception layer-equipped base material is used. Still further, in the first and second electronic circuit board manufacturing methods of the present invention, the base material may be turned into a reception layer-equipped base material having a porous reception layer formed on a surface thereof. This will result in that the metal colloid solution is applied on the reception layer, so that the adhesion between the base material and conductive pattern formed with the metal colloid solution may be increased. Consequently, even when the solvent of the metal colloid solution and the coagulant solution are applied on top of each other, the shape of the conductive pattern formed with the metal colloid solution is ensured. This allows, therefore, the application amount of the coagulant solution to be increased, whereby the cohesiveness of the metal colloidal fine particles may further be enhanced. Further, the conductive pattern formed is free from defects as wiring, such as a short circuit or an open circuit.

### BRIEF DESCRIPTION OF THE DRAWINGS

FIG. 1 is a drawing conceptually illustrating an electronic circuit board manufacturing method according to a first embodiment of the present invention.

FIGS. 2A to 2D are drawings for explaining an application area of a coagulant.

FIG. 3 is a drawing conceptually illustrating an electronic circuit board manufacturing method according to a second embodiment of the present invention.

FIG. 4 is a drawing conceptually illustrating an electronic circuit board manufacturing method according to a third embodiment of the present invention.

FIG. 5 is a drawing conceptually illustrating an electronic circuit board manufacturing method according to a fourth embodiment of the present invention.

FIG. 6 is a table of SP values of various types of solvents.

FIG. 7 is a drawing schematically illustrating a wiring pattern forming method when subtractive method is used.

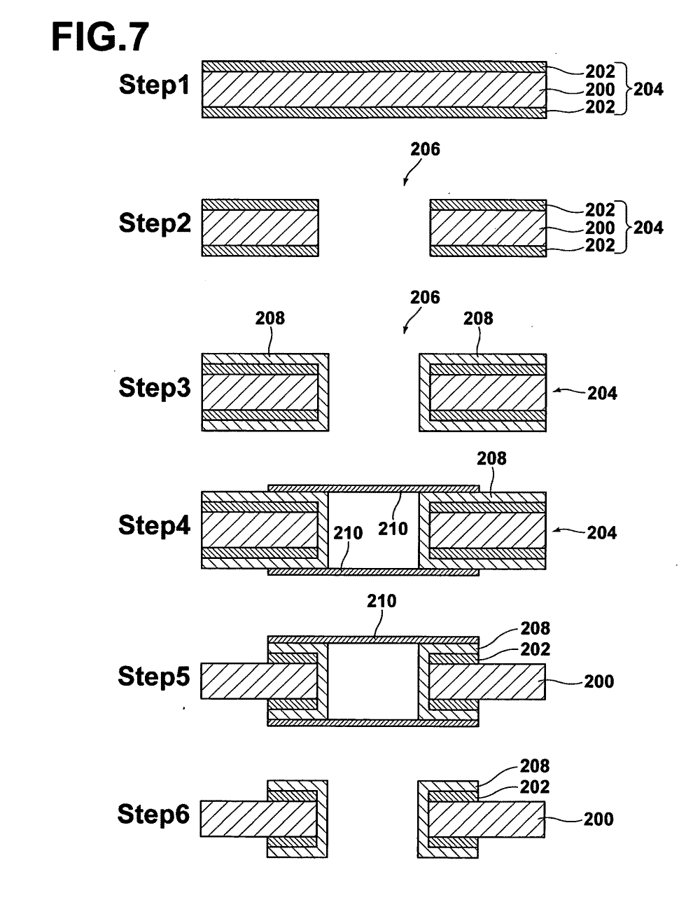

FIG. 8 is a drawing schematically illustrating a wiring pattern forming method when semi-additive method is used.

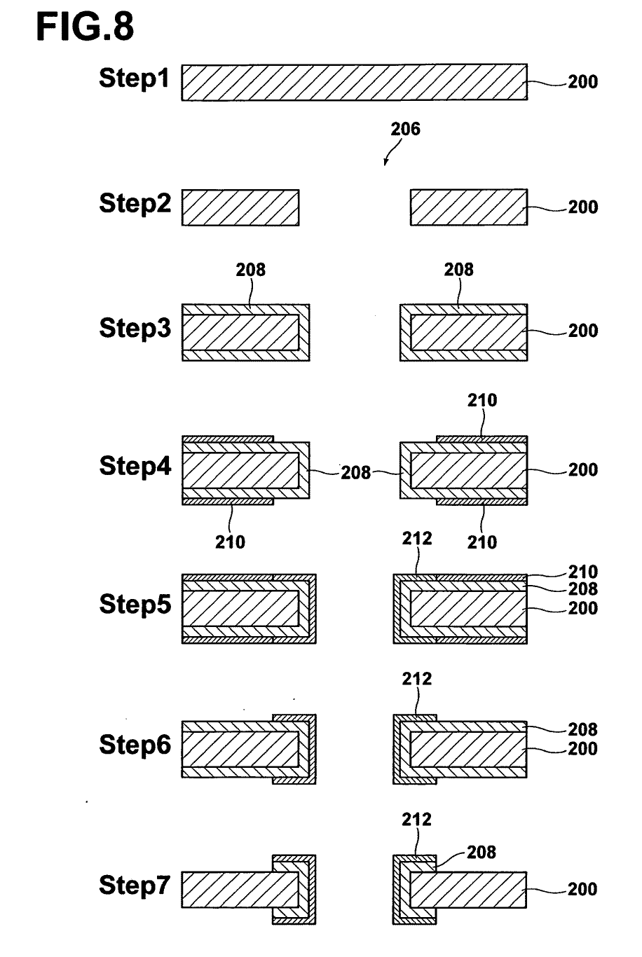

FIG. 9 is a drawing schematically illustrating a wiring pattern forming method when additive method is used.

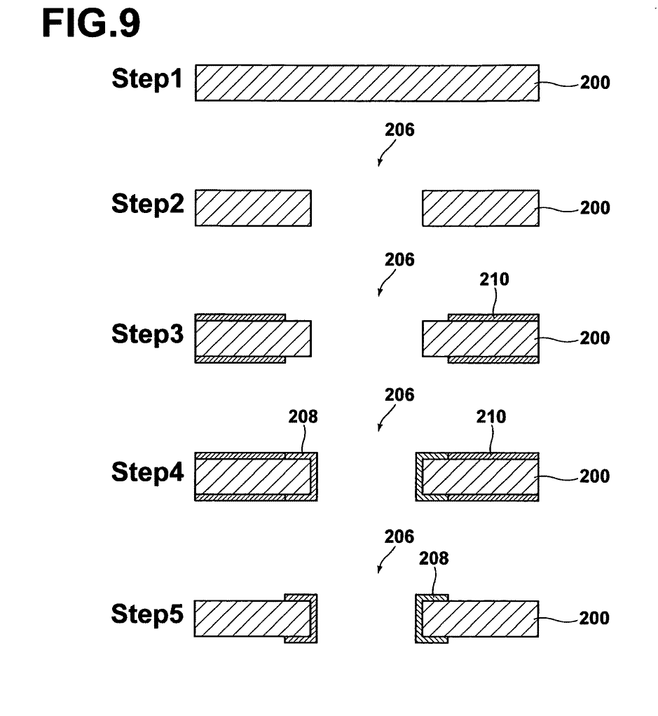

### DESCRIPTION OF THE PREFERRED EMBODIMENTS

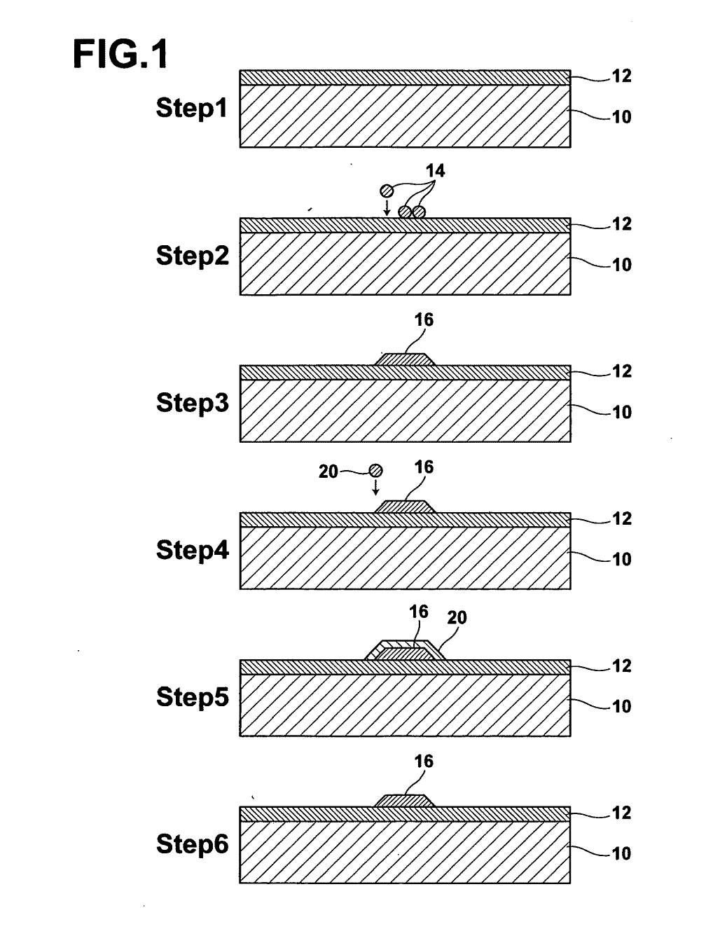

Hereinafter, embodiments of the present invention will be described with reference to the accompanying drawings. FIG. 1 is a drawing conceptually illustrating an electronic circuit board manufacturing method according to a first embodiment of the present invention.

First, as shown in Step 1, reception layer 12 is formed on one surface of base material 10. Note that reception layer 12 may be formed on each surface of base material 10. Further, base material 10 having reception layer 12 formed thereon in advance may be used.

Next, as shown in Step 2, metal colloid solution 14 is discharged by an inkjet method and applied on the surface of reception layer 12 in a conductive pattern. More specifically, metal colloid solution 14 is discharged by the inkjet method based on image data of the conductive pattern, whereby metal colloid solution 14 is applied on the surface of reception layer 12. The detail of metal colloid solution 14 will be described later.

As the inkjet method, any of the thermal method, piezo method, and electrostatic method may be used, but the piezo method is more preferably used. In the case of the thermal method, it is preferable that metal colloid solution 14 is a solution which includes an aqueous vehicle, and in the case of the electrostatic method, it is necessary to charge metal colloidal particles of metal colloid solution 14 by coating the particles with a resin.

Right after metal colloid solution 14 is discharged on the surface of reception layer 12 by the inkjet method in the manner as described above, the droplets of metal colloid solution 14 are arranged side by side, as shown in Step 2, but immediately thereafter the droplets penetrate into reception layer 12 to form conductive metal portion 16 which is trapezoidal in cross-section as shown in Step 3. Where reception layer 12 has a high porosity, metal colloidal particles included in metal colloid solution 14 may enter into the porosities and conductive metal portion 16 shaped in an upside-down trapezoid of Step 3, having a lower side shorter than an upper side, may sometimes be formed.

Here, when metal colloid solution 14 is applied by an inkjet method, a coagulant solution for metal colloid solution 14 is also applied by the inkjet method in a latter stage, so that two process steps may be performed within the same equipment. Therefore, the equipment may be downsized and the numbers of equipment units and process steps may be reduced in comparison with the case in which an electronic circuit board is manufactured by photolithography. Further, as the numbers of equipment units and process steps are reduced, so does the overall processing time, which is favorable from the viewpoint of productivity.

When metal colloid solution 14 penetrates into reception layer 12, a dispersant dispersed in metal colloid solution 14 is absorbed with the solvent at the same time by reception layer 12, whereby dispersion collapse of metal colloid solution 14 is started. In order to fully induce conductivity of metal colloidal particles in metal colloid solution 14, i.e., in order to cause the metal colloidal particles to have a sufficiently low resistance as a conductive pattern, however, a heat treatment or a standing period of several days at room temperature is required. In the first embodiment, therefore, coagulant solution 20 is applied to the conductive pattern portion formed of metal colloid solution 14 in place of such processing as described above. More specifically, as shown in Step 4, a coagulant solution 20 is applied on the conductive pattern (conductive metal portion 16) of applied metal colloid solution 14 by the inkjet method. The detail of the coagulant solution 20 will be described later.

Preferably, the coating amount of coagulant solution 20 is as much as possible so that the entirety of conductive metal portion 16 formed of metal colloid solution 14 is soaked with coagulant solution 20, as shown in Step 5, within a range in which the pattern of conductive metal portion 16 does not collapse. For this purpose, coagulant solution 20 is dropped and applied to the conductive pattern area at least once and preferably a plurality of times. It is preferable that an inkjet head capable of discharging a larger droplet than that of an inkjet head for discharging metal colloid solution 14 is used for the discharge of coagulant solution 20. Further, coagulant solution 20 may be applied by a dispenser method instead of the inkjet method. This may increase the coating amount of coagulant solution.

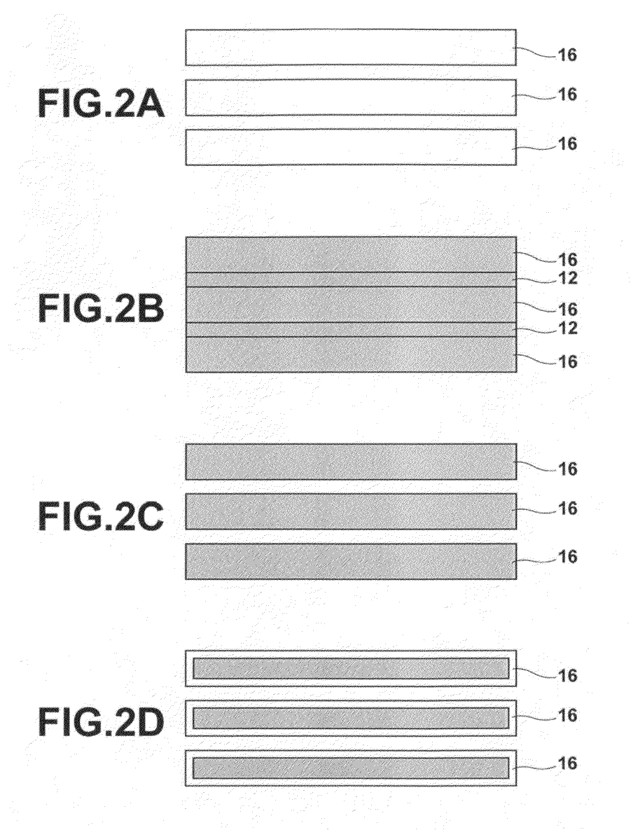

Preferably, the coating amount of coagulant solution 20 is as much as possible, but the optimum amount of coagulant solution 20 is that which, when coagulant solution 20 is applied over the entire area of conductive pattern formed of metal colloid solution 14, is kept by the surface tension of coagulant solution 20 within the entire area of the conductive pattern without overflowing. Here, the entire area of conductive pattern as used herein refers to the area on which a conductive pattern is formed and an area corresponding to a spacing of the pattern (i.e., area of reception layer 12). More specifically, for example, when coagulant solution 20 is applied on a conductive pattern in which three conductive metal portions 16 are formed side by side at a predetermined spacing as shown in FIG. 2A, a rectangular area, including areas of reception layer 12 present between each of the three conductive metal portions 16, is the entire area of the conductive pattern. In this case, coagulant solution 20 is applied to the rectangular area, including the areas of reception layer 12 present between each of conductive metal portions 16, as shown in FIG. 2B. Note that, in FIGS. 2A to 2D, coagulant solution 20 is indicated in gray.

Further, coagulant solution 20 may be applied only to conductive metal portions 16, as shown in FIG. 2C. Alternatively, coagulant solution 20 may be applied only to inner areas of conductive metal portions 16, as shown in FIG. 2D. This may avoid the application of coagulant solution 20 to unnecessary areas and the amount of coagulant solution 20 used may be reduced.

In the first embodiment, coagulant solution 20 may be applied only to the conductive pattern area (including entire area of conductive pattern described above) by the use of inkjet method as shown in FIGS. 2B to 2D, whereby application of coagulant solution 20 to unnecessary areas is not required. Consequently, cracking, detachment, or swelling of the conductive pattern may not be induced and also reception layer 12 may not be damaged.

After coagulant solution 20 is applied in the manner as described above, a drying treatment is performed as required. This completes the formation of a conductive pattern of conductive metal portion 16, as shown in Step 6. As the drying method, drying at room temperature is sufficient. After coagulant solution 20 is applied, allowing the pattern to stand for at least several hours at room temperature may induce conductivity so that the standing time may be reduced in comparison with the case in which coagulant solution 20 is not applied.

By the method described above, an electronic circuit board is manufactured.

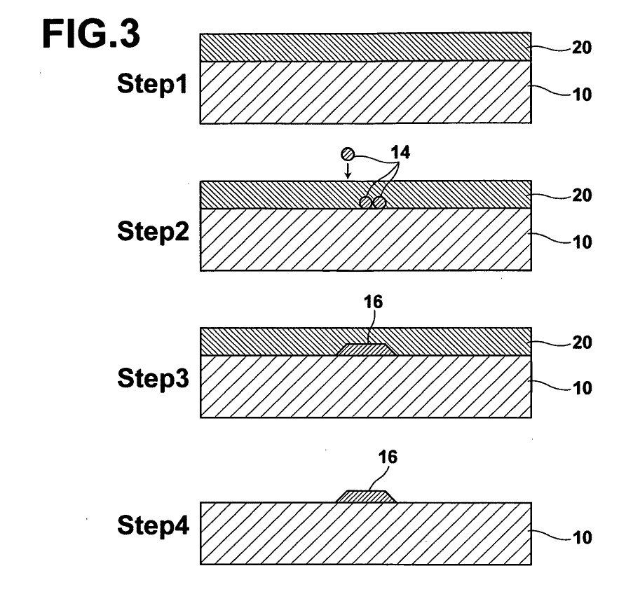

Next, a second embodiment of the present invention will be described. FIG. 3 is a drawing conceptually illustrating an electronic circuit board manufacturing method according to the second embodiment of the present invention.

In the second embodiment, first coagulant solution 20 is applied over the entire surface of base material 10, as shown in Step 1. In the second embodiment, although the inkjet method or dispenser method may be used, an overall coating method, such as a bar coating method, is more preferably used. This may simplify the coating process of coagulant solution 20, whereby the manufacturing cost of an electronic circuit board may be reduced.

Then, as shown in Step 2, metal colloid solution 14 is discharged by an inkjet method and applied on the surface of base material 10 having coagulant solution 20 applied thereon in a conductive pattern. More specifically, metal colloid solution 14 is discharged by the inkjet method based on image data of the conductive pattern, whereby metal colloid solution 14 is applied on the surface of base material 10 having coagulant solution 20 applied thereon.

Right after metal colloid solution 14 is discharged by the inkjet method in the manner as described above, the droplets of metal colloid solution 14 are arranged side by side, as shown in Step 2, but immediately thereafter the droplets turn into conductive metal portion 16 which is trapezoidal in cross-section as shown in Step 3.

Thereafter, a drying treatment is performed as required. This completes the formation of a conductive pattern of conductive metal portion 16, as shown in Step 4. As the drying method, drying at room temperature is sufficient. After coagulant solution 20 is applied, allowing the pattern to stand for at least several hours at room temperature may induce conductivity so that the standing time may be reduced in comparison with the case in which coagulant solution 20 is not applied.

In the second embodiment, coagulant solution 20 may be applied over the entire surface of base material 10 after forming reception layer 12 on base material 10, as in the first embodiment. Further, the coagulant solution 20 may be applied only to an area of base material 10 in which a conductive pattern is formed.

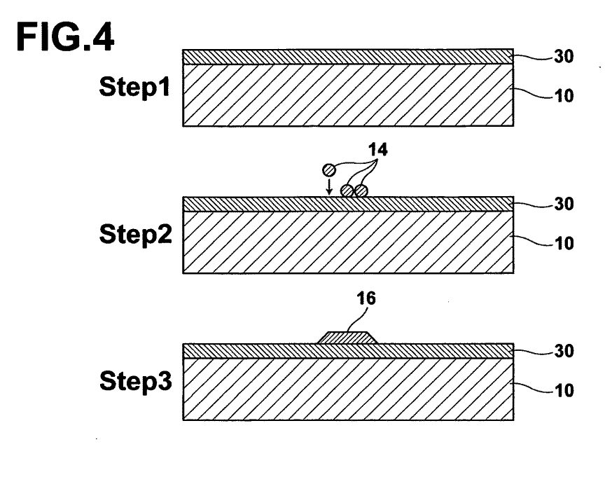

Next, a third embodiment of the present invention will be described. FIG. 4 is a drawing conceptually illustrating an electronic circuit board manufacturing method according to the third embodiment of the present invention. First, as shown in Step 1, coagulant added reception layer 30, to which a coagulant is added, is formed on one surface of base material 10. Coagulant added reception layer 30 may be formed, for example, by applying a mixed solution of a porous reception layer forming component and a coagulant over the entire surface of base material 10. Here, the mixed solution may be prepared by adding the coagulant to a reception layer forming solution which includes the porous reception layer forming component, adding the porous reception layer forming component to a coagulant solution, or in-line mixing the reception layer forming solution and coagulant solution. The application of the mixed solution may be carried out by the inkjet method, dispenser method, or overall coating method, such as bar coating method, as in the second embodiment.

In the third embodiment, coagulant added reception layer 30 may be formed on each surface of base material 10. Further, base material 10 having coagulant added reception layer 30 formed thereon in advance may be used. Coagulant added reception layer 30 may be formed only in the area of base material 10 in which a conductive pattern is formed. Methods for forming base material 10 and coagulant added reception layer 30, and coagulant added reception layer 30 will be described later.

Next, as shown in Step 2, metal colloid solution 14 is discharged by an inkjet method and applied on the surface of reception layer 30. More specifically, metal colloid solution 14 is discharged by the inkjet method based on image data of the conductive pattern, whereby metal colloid solution 14 is applied on the surface of base material 10 having coagulant added reception layer 30 formed thereon.

Right after metal colloid solution 14 is discharged by the inkjet method in the manner as described above, the droplets of metal colloid solution 14 are arranged side by side, as shown in Step 2, but immediately thereafter the droplets turn into conductive metal portion 16 which is trapezoidal in cross-section as shown in Step 3. At this time, the coagulant added to coagulant added reception layer 30 spreads into conductive metal portion 16. Thereafter, a drying treatment is performed as required. This completes the formation of a conductive pattern of conductive metal portion 16.

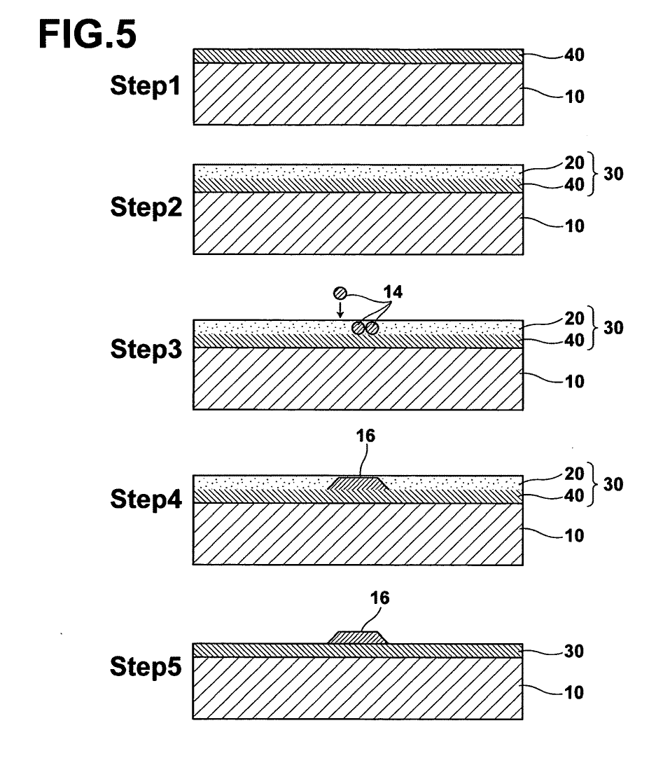

Next, a fourth embodiment of the present invention will be described. FIG. 5 is a drawing conceptually illustrating an electronic circuit board manufacturing method according to the fourth embodiment of the present invention. The electronic circuit board manufacturing method according to the fourth embodiment is a method in which formation of coagulant added reception layer 30 in the third embodiment is described in detail.

In the fourth embodiment, as shown in Step 1, reception layer forming solution 40 having a porous reception layer forming component is applied over the entire surface of base material 10. Then, as shown in Step 2, coagulant solution 20 is applied over reception layer forming solution 40 during a drying step of reception layer forming solution 40. In this state, reception layer forming solution 40 is not yet dried, so that the application of coagulant solution 20 causes reception layer forming solution 40 and coagulant solution 20 to be mixed together and turned into coagulant added reception layer 30. In the coagulant added reception layer 30, however, coagulant solution 20 is distributed on the upper side of reception layer forming solution 40. The coagulant solution 20 may be applied simultaneously with reception layer forming solution 40. Also, in this case, reception layer forming solution 40 and coagulant solution 20 are mixed together, but coagulant solution 20 is distributed on the upper side of reception layer forming solution 40. The application of reception layer forming solution 40 and coagulant solution 20 may be carried out by the inkjet method, dispenser method, or overall coating method, such as bar coating method, as in the second embodiment.

Then, as shown in Step 3, metal colloid solution 14 is discharged by an inkjet method and applied on the surface of base material 10 in a conductive pattern during a drying step of reception layer forming solution 40 and coagulant solution 20 (coagulant added reception layer 30). Right after metal colloid solution 14 is discharged by the inkjet method in the manner as described above, the droplets of metal colloid solution 14 are arranged side by side on the upper side of reception layer forming solution 40 of coagulant added reception layer 30, as shown in Step 3, but immediately thereafter the droplets turns into conductive metal portion 16 which is trapezoidal in cross-section as shown in Step 4. Thereafter, when reception layer forming solution 40 and coagulant solution 20 are dried, the formation of coagulant added reception layer 30 and a conductive pattern of conductive metal portion 16 is completed, as shown in Step 5.

Here, in the fourth embodiment, application of metal colloid solution 14 is performed during a drying step of reception layer forming solution 40 and coagulant solution 20 (coagulant added reception layer 30), but the metal colloid solution 14 may be applied after reception layer forming solution 40 and coagulant solution 20 are dried. In this case, the application mode of metal colloid solution 14 is identical to that of the third embodiment.

In the first to fourth embodiments, plating may be performed, as required, on conductive metal portion 16 to provide a plated coating for preventing oxidization, mounting an electronic component, and the like.

Further, in the first to fourth embodiments, solder resist processing may be performed, as required, on conductive metal portion 16 for protecting the conductive pattern, preventing oxidization, preventing short circuiting due to contact with other metals, and the like.

Although reception layer 12 is formed on base material 10 in the first embodiment, but metal colloid solution 14 may be applied directly to base material 10 without forming reception layer 12.

Further, in the first to fourth embodiments, electronic circuit boards are manufactured, but the method of the present invention is not limited to this and may also manufacture electromagnetic wave shielding film for PDP that requires transparency and an electromagnetic wave shielding function (conductivity effect).

Preferably, an electromagnetic wave shielding film (conductivity metal portion) for PDP manufactured by the present invention has a surface resistance value of not greater than 10Ω/□, more preferably not greater than 2.5Ω/□ when used as a material of transparent electromagnetic wave shield and not greater than 1.5Ω/□ when used in a consumer plasma television using a PDP, and further preferably not greater than 0.5Ω/□.

Preferably, the conductive metal portion, when used in an electromagnetic shielding film for PDP, has a line width not greater than 20 μm and a line interval not smaller than 50 μm. Further, the conductive metal portion may have a section having a greater line width than 20 μm for ground connection. Preferably, conductive metal portion has a line width not greater than 15 μm, more preferably not greater than 10 μm, and further preferably not greater than 7 μm from the viewpoint of making less recognizable.

Preferably, the conductive metal portion, when used in an electromagnetic shielding film for PDP, has an aperture ratio not smaller than 85%, more preferably not smaller than 90%, and further preferably not smaller than 95% from the viewpoint of transmittance of visible light. The “aperture ratio” as used herein refers to a ratio of area portions without a thin line forming a mesh to the entire area. For example, the aperture ratio of a square grid mesh with a line width of 10 μm and a pitch of 200 μm is 90%. Preferably, the conductive metal portion of the present invention has an aperture ratio not greater than 98% from the viewpoint of the relationship between the values of surface resistance and line width, although there is not a specific upper limit.

Preferably, the conductive metal portion, when used in an electromagnetic shielding film for PDP, has a thickness as thin as possible for the application of display because a thinner thickness may provide a wider viewing angle. From this viewpoint, it is preferable that a layer of conductive metal supported by the conductive metal portion has a thickness less than 9 μm, more preferably in the range from 0.1 μm to less than 5 μm, and further preferably in the range from 0.1 μm to less than 3 μm.

Materials for forming base material 10, reception layer 12, conductive metal portion 16, and coagulant solution 20 will be described in detail.

There is not any specific restriction on base material 10 and the following may be used: papers, such as inkjet papers, resin laminated papers, resin films, resin substrates, silicon substrates, ceramics substrates, glass substrates, and the like. Further, metal base materials, such as aluminum, having an insulated surface may also be used.

As for the materials of resin laminated papers, resin films, and resin substrates, the following may be cited as examples. That is, polyester series (polyimide, polyethylene terephthalate, polyethylene naphthalate, and the like, polycarbonate series, cellulose ester series, polyarylate series, polysulphone series (including polyether sulfone), polyethylene, polypropylene, polystyrene, polyvinyl chloride, polyvinylidene chloride, polyvinyl alcohol, ethylene-vinylalcohol, syndiotactic polystyrene series, polycarbonate, cycloolefin polymer CARTON, manufactured by JSR Corporation), ZEONEX® and ZEONOR® (Nippon Zeon Co., Ltd), polymethylpentene, polyether ketone, polyether ether ketone, polyether ketone imide, polyamide, fluorine resin, nylon, polymethylmethacrylate, polyacrylate series, polyarylate series, triacetylcellulose, and the like may be used. The resin film and resin substrate may be used in the form of a single layer, but they may be used as a multilayer film having two or more layers stacked on top of each other.

As for base material 10 for manufacturing an electromagnetic wave shielding film, for example, resin films, such as polyimide film, polyamide-imide film, polyamide film, polyester film, glass-epoxy substrates, silicon substrates, ceramics substrates, glass substrates, and the like described in Japanese Unexamined Patent Publication No. 2008-066568. From the viewpoint of handlability, however, sheet-like resin films are preferably used. Electromagnetic wave shielding films require a high transparency, and it is, therefore, preferable to use a transparent resin film or a glass substrate as the base material for manufacturing an electromagnetic wave shielding film. Further, a base material colored to a degree that does not hinder the required transparency may also be used.

In this case, there is not any specific restriction on the material of the resin film and those described above may be used. The resins described above may be used in the form of a single layer, but also as a multilayer film having two or more layers stacked on top of each other. As base material 10 for manufacturing an electromagnetic wave shielding film, a polyethylene terephthalate film, a polyethylene naphthalate film, or a cellulose ester film is preferably used from the viewpoint of transparency, heat resistance, handlability, and economy. Among them, the cellulose ester film is more preferably used from the viewpoint of transparency, isotropy, adhesiveness, and the like.

Reception layer 12 used in the present invention is a porous reception layer which includes at least one of cationic-modified self-emulsifying polymer, inorganic fine particle, polyvinyl alcohol having a saponification value of 82 to 98 mol %, water soluble aluminum compound, zirconium compound, and cross-linking agent as the layer forming component.

### <Cationic-Modified Self-Emulsifying Polymer>

Reception layer 12 of the present invention includes a “cationic-modified self-emulsifying polymer”. The “cationic-modified self-emulsifying polymer” as used herein refers to a polymer that can spontaneously become a stable emulsified dispersion substance in an aqueous dispersion solution without using or with a very small amount of emulsifier or surfactant. Quantitatively speaking, the “cationic-modified self-emulsifying polymer” represents a high-molecular material stably having emulsification and dispersibility with a concentration of not less than 0.5 mass % in an aqueous dispersion solution at room temperature of 25° C. As for the concentration, not less than 1 mass % is preferable and not less than 3 mass % is more preferable.

More specifically, the “cationic-modified self-emulsifying polymer” includes, for example, polyaddition system or polycondensation system polymers having a cationic group, such as primary to tertiary amino groups, quaternary ammonium group, and the like.

Vinyl polymerization system polymers effective as the polymers include, for example, polymers obtained by polymerizing the following vinyl monomers. That is, acrylic acid and methacrylic acid esters (ester groups are alkyl groups which may have a substituent, or aryl groups, which include, for example, methyl group, ethyl group, n-propyl group, isopropyl group, n-butyl group, sec-butyl group, tert-butyl group, hexyl group, 2-ethylhexyl group, tert-octyl group, 2-chloroethyl group, cyanoethyl group, 2-acetoxyethyl group, tetrahydrofurfuryl group, 5-hydroxypentyl group, cyclohexyl group, benzyl group, hydroxyethyl group, 3-methoxybutyl group, 2-(2-methoxyethoxy) ethyl group, 2,2,2-tetrafluoroethyl group, 1H,1H,2H,2H-perfluorodecyl group, phenyl group, 2,4,5-tetramethylphenyl group, 4-chlorophenyl group, and the like), vinyl esters, more specifically, aliphatic carboxylic acid vinyl esters which may have a substituent (e.g., vinyl acetate, vinyl propionate, vinyl butyrate, vinyl isobutyrate, vinyl caproate, vinyl chloroacetate, and the like), aromatic carboxylic acid vinyl esters which may have a substituent (e.g., vinyl benzoate, 4-methyl vinyl benzoate, vinyl salicylate, and the like), acrylamides, more specifically, acrylamide, N-monosubstituted acrylamide, N-disubstituted acrylamide (substituents are alkyl groups which may have a substituent, aryl groups, or silyl groups, which include, for example, methyl group, n-propyl group, isopropyl group, n-butyl group, tert-butyl group, tert-octyl group, cyclohexyl group, benzyl group, hydroxymethyl group, alkoxymethyl group, phenyl group, 2,4,5-tetramethylphenyl group, 4-chlorophenyl group, trimethylsilyl group, and the like), methacrylamides, more specifically, methacrylamide, N-monosubstituted methacrylamide, N-disubstituted methacrylamide (substituents are alkyl groups which may have a substituent, aryl groups, or silyl groups, which include, for example, methyl group, n-propyl group, isopropyl group, n-butyl group, tert-butyl group; tert-octyl group, cyclohexyl group, benzyl group, hydroxymethyl group, alkoxymethyl group, phenyl group, 2,4,5-tetramethylphenyl group, 4-chlorophenyl group, trimethylsilyl, and the like), olefins (e.g., ethylene, propylene, 1-pentene, vinyl chloride, vinylidene chloride, isoprene, chloroprene, butadiene, and the like), styrenes (e.g., styrene, methyl styrene, isopropyl styrene, methoxy styrene, acetoxy styrene, chloro styrene, and the like), vinyl ethers (e.g., methyl vinyl ether, butyl vinyl ether, hexyl vinyl ether, methoxy ethyl vinyl ether, and the like), and the like.

As other vinyl monomers, the following are cited: crotonic acid ester, itaconic acid ester, maleic acid diester, fumaric acid diester, methyl vinyl ketone, phenyl vinyl ketone, methoxy ethyl vinyl ketone, N-vinyl oxazolidone, N-vinyl pyrrolidone, methylene malononitrile, diphenyl-2-acryloyloxyethyl phosphate, diphenyl-2-methacryloyloxyethyl phosphate, dibutyl-2-acryloyloxyethyl phosphate, dioctyl-2-methacryloyloxyethyl phosphate, and the like

As for monomers having a cationic group, for example, those having a tertiary amino group, such as dialkylaminoethyl methacrylate, dialkylaminoethyl acrylate, and the like may be cited.

Polyurethanes applicable to the cationic-modified self-emulsifying polymer include, for example, polyurethanes synthesized by variously combining the following diol compounds with diisocyanate compounds and through polyaddition reaction.

Specific diol compounds include ethylene glycol, 1,2-propanediol, 1,3-propanediol, 1,2-butanediol, 1,3-butanediol, 2,3-butanediol, 2,2-dimethyl-1,3-propanediol, 1,2-pentanediol, 1,4-pentanediol, 1,5-pentanediol, 2,4-pentanediol, 3,3-dimethyl-1,2-butanediol, 2-ethyl-2-methyl-1,3-propanediol, 1,2-hexanediol, 1,5-hexanediol, 1,6-hexanediol, 2,5-hexanediol, 2-methyl-2,4-pentanediol, 2,2-diethyl-1,3-propanediol, 2,4-dimethyl-2,4-pentanediol, 1,7-heptanediol, 2-methyl-2-propyl-1,3-propanediol, 2,5-dimethyl-2,5-hexanediol, 2-ethyl-1,3-hexanediol, 1,2-octanediol, 1,8-octanediol, 2,2,4-trimethyl-1,3-pentanediol, 1,4-cyclohexanedimethanol, hydroquinone, diethylene glycol, triethylene glycol, dipropylpyrene glycol, tripropylpyrene glycol, polyethylene glycol (average molecular weight=200, 300, 400, 600, 1,000, 1,500, or 4,000), polypropylene glycol (average molecular weight=200, 400, or 1,000), polyester polyol, 4,4′-dihydroxy-diphenyl-2,2-propane, 4,4′-dihydroxyphenyl sulfone, and the like.

Specific diisocyanate compounds include methylene diisocyanate, ethylene diisocyanate, isophorone diisocyanate, hexamethylene diisocyanate, 1,4-cyclohexane diisocyanate, 2,4-toluene diisocyanate, 2,6-toluene diisocyanate, 1,3-xylylene diisocyanate, 1,5-naphthalene diisocyanate, m-phenylene diisocyanate, p-phenylene diisocyanate, 3,3′-dimethyl-4,4′-diphenylmethane diisocyanate, 3,3′-dimethylbiphenylene diisocyanate, 4,4′-biphenylene diisocyanate, dicyclohexylmethane diisocyanate, methylenebis (4-cyclohexyl diisocyanate), and the like.

As for the cationic groups of polyurethane having a cationic group, cationic groups, such as primary to tertiary amines, quaternary ammonium salts, and the like are cited. As for the cationic-modified self-emulsifying polymer used in the present invention, urethane resins having such cationic groups as tertiary amine and quaternary ammonium salt are preferably used.

Polyurethane having a cationic group may be obtained, for example, by using a cationic group introduced diol when forming the polyurethane as described above. In the case of quaternary ammonium salt, polyurethane having a tertiary amino group may be quaternarized by a quaternarizing agent.

Each of the diol compounds and diisocyanate compounds usable for synthesizing the polyurethane may be used solely or in combination with one or more of other compounds in various proportions depending on the purpose (for example, control of the polymer glass transition temperature (Tg), improving solubility, providing compatibility with a binder, and improving stability of a dispersion).

Polyesters applicable to the cationic-modified self-emulsifying polymer include, for example, polyesters synthesized by variously combining the following diol compounds with dicarboxylic acid compounds and through polycondensation reaction.

The dicarboxylic acid compounds include oxalic acid, malonic acid, succinic acid, glutaric acid, dimethylmalonic acid, adipic acid, pimelic acid, α,α-dimethylsuccinic acid, acetonedicarboxylic acid, sebacic acid, 1,9-nonanedicarboxylic acid, fumaric acid, maleic acid, itaconic acid, citraconic acid, phthalic acid, isophthalic acid, terephthalic acid, 2-butylterephthalic acid, tetrachloroterephthalic acid, acetylenedicarboxylic acid, poly(ethyleneterephthalate) dicarboxylic acid, 1,2-cyclohexanedicarboxylic acid, 1,4-cyclohexanedicarboxylic acid, ω-poly(ethyleneoxide) dicarboxylic acid, p-xylylenedicarboxylic acid and the like.

When polycondensed with a diol compound, each of the dicarboxylic acid compounds may be used in the form of an alkyl ester (for example, dimethyl ester) of a dicarboxylic acid or an acid chloride of a dicarboxylic acid, or in the form of an acid anhydride such as maleic anhydride, succinic anhydride, and phthalic anhydride.

As for the diol compound, those cited in the polyurethane may be used.

Polyesters having a cationic group may be obtained by performing the synthesis using a dicarboxylic acid compound having a cationic group, such as primary, secondary, or tertiary amine, or a quaternary ammonium salt.

Each of the diol compounds, dicarboxylic acids and hydroxycarboxylate ester compounds used in synthesizing the polyester may be used solely or in combination with one or more of other compounds in any proportion depending on the purpose (for example, control of the polymer glass transition temperature (Tg), solubility, compatibility with dyes, and stability of dispersion).

Preferably, the content of the cationic group in the cationed self-emulsifying polymer is in the range from 0.1 to 5 mmol/g, and more preferably in the range from 0.2 to 3 mmol/g. When the content of the cationic group is too low, the polymer dispersion stability decreases, and when too high, compatibility with binder decreases.

As for the cationed self-emulsifying polymer, a polymer having a cationic group, such as a tertiary amine group or a quaternary ammonium salt group, is preferably used and an urethane resin (polyurethane) having a cationic group described above is more preferably used.

When the self-emulsifying polymer is used for reception layer 12, the glass transition temperature thereof is particularly important. In order to prevent temporal bleeding of a conductive layer over a long period of time after being formed by the inkjet method, it is preferable to use a self-emulsifying polymer having a glass transition temperature less than 50° C. Further, it is more preferable to use a self-emulsifying polymer having a glass transition temperature not greater than 30° C., and it is further preferable to use a self-emulsifying polymer having a glass transition temperature not greater than 15° C. If the glass transition temperature is 50° C. or above, the dimensional stability (curl) may be degraded. There is not any specific restriction on the lower limit of the glass transition temperature, and it is around −30° C. for ordinary applications. If the glass transition temperature is lower than this, the manufacturability may be reduced when preparing the aqueous dispersion material.

Preferably, the mass average molecular weight (Mw) of the self-emulsifying polymer is in the range from 1,000 to 200,000, and more preferably in the range from 2,000 to 50,000. A molecular weight of less than 1,000 may make it difficult to obtain a stable aqueous dispersion material, while a molecular weight of over 200,000 may reduce the solubility and increase the viscosity of the liquid, causing it difficult to control the average particle diameter of the aqueous dispersion material to a small value, particularly to 0.05 μm or less.

Preferably, the content of the self-emulsifying polymer in reception layer 12 is in the range from 0.1 to 30 mass % of the total solid mass forming reception layer 12, more preferably in the range from 0.3 to 20 mass %, and further preferably in the range from 0.5 to 15 mass %. The content of less than 0.1 mass % results in an insufficient improvement in the temporal bleeding. On the other hand, the content over 30 mass % reduces the proportion of inorganic fine particles and a binder component, such as polyvinyl alcohol, whereby the solvent absorptivity of reception layer 12 for metal colloid solution 14 is reduced.

Next, a method for preparing an aqueous dispersion material of self-emulsifying polymer will be described.

An aqueous dispersion solution of self-emulsifying polymer with an average particle diameter of not greater than 0.05 μm may be obtained by mixing a self-emulsifying polymer with an aqueous medium, blending an additive as required, and grain refining the mixed solution using a disperser. Various known dispersers may be used for obtaining the aqueous dispersion solution, such as high speed rotary dispersers, medium agitation type dispersers (such as ball mill, sand mill, and bead mill), ultrasonic dispersers, colloid mill dispersers, high pressure dispersers. From the viewpoint of efficient dispersion of granular mass of fine particles, the medium agitation type disperser, colloid mill disperser or high pressure disperser is preferably used.

Mechanisms of high pressure dispersers (homogenizers) are detailed in U.S. Pat. No. 4,533,254 and Japanese Unexamined Patent Publication No. 6 (1994) -047264, and commercially available dispersers, such as Gaulin Homogenizer (Gaulin Inc.), Microfluidizer (Microfluidex Inc.), Altimizer (Sugino Machine K.K.), and the like may be used. A recent high pressure homogenizer having a mechanism for performing microparticulation in an ultrahigh pressure jet flow as described, for example, in U.S. Pat. No. 5,720,551 is particularly effective for emulsifying dispersion of the present invention. DeBEE2000 (Bee International Ltd.) is as an example of the emulsifying device using the ultrahigh pressure jet flow.

For the aqueous medium used in the dispersing process, water, na organic solvent, or a mixture thereof may be used. Organic solvents usable for the dispersion include alcohols, such as methanol, ethanol, n-propanol, i-propanol, and methoxy propanol, ketones such as acetone, and methyl ethyl ketone, tetrahydrofuran, acetonitrile, ethyl acetate, toluene, and the like.

The self-emulsifying polymer of the present invention may spontaneously becomes a stable emulsified dispersion material by itself. In order to speed up or stabilize the emulsifying dispersion, however, a small amount of dispersant (surfactant) may be used. For this purpose, various surfactants can be used. Preferable examples are anionic surfactants, such as fatty acid salts, alkylsulfate ester salts, alkylbenzenesulfonate salts, alkylnaphthalenesulfonate salts, dialkylsulfosuccinate salts, alkylphosphate ester salts, naphthalenesulfonic acid formalin condensates, polyoxyethylene alkylsulfate ester salts and the like, and nonionic surfactants, such as polyoxyethylene alkyl ethers, polyoxyethylene alkylaryl ether, polyoxyethylene fatty acid esters, sorbitan fatty acid esters, polyoxyethylene sorbitan fatty acid esters, polyoxyethylene alkyl amines, glycerine fatty acid esters, oxyethylene oxypropylene block copolymers, and the like. Further, SURFYNOLS (Air Products & Chemicals), an acetylene-based polyoxyethylene oxide surfactant is also preferably used. Further, amine oxide type ampholytic surfactants such as N,N-dimethyl-N-alkylamine oxide, and the like are also preferable. Further, surfactants listed in Japanese Unexamined Patent Publication No. 59 (1984)-157636, pp. 37 and 38, and Research Disclosure No. 308119 (1989) may be used.

For the stabilization right after the emulsification, a water-soluble polymer may also be added in addition to the surfactant described above. As the water-soluble polymer, polyvinyl alcohols, polyvinyl pyrrolidone, polyethylene oxide, polyacrylic acid, polyacrylamide, and copolymers thereof are preferably used. Further, it is also preferable to use natural water-soluble polymers, such as polysaccharides, casein, gelatin and the like.

When dispersing a self-emulsifying polymer in an aqueous medium by the emulsifying dispersing method, particle size control is particularly important. In order to increase the purity and density of metal colloid when a conductive pattern is formed by the inkjet method, it is necessary to reduce the average particle size of the self-emulsifying polymer in the aqueous dispersion. More specifically, it is preferable that the volume average particle diameter is not greater than 0.05 μm, more preferably not greater than 0.04 μm, and further preferably not greater than 0.03 μm for reception layer 12 of the present invention.

### <Inorganic Fine Particles>

Reception layer 12 of the present invention includes inorganic fine particles. Examples of the inorganic fine particles include silica particles, colloidal silica, titanium dioxide, barium sulfate, calcium silicate, zeolite, kaolinite, halloysite, mica, talc, calcium carbonate, magnesium carbonate, calcium sulfate, boehmite, pseudoboehmite. Among them, silica fine particles are preferable.

The silica fine particles have an advantage that they have an extremely high specific surface area, thereby providing the layer with a high absorption and retention capacity of the solvent of metal colloid solution 14. In addition, the silica fine particles have a low refractive index, so that the dispersion of the particles to a suitable particle diameter may give reception layer 12 better transparency. Such transparency of reception layer 12 is important where transparency is required, such as an electromagnetic wave shielding film for PDP and the like.

Preferably, the average primary particle diameter of the inorganic fine particles is not greater than 20 nm, more preferably not greater than 15 nm, and particularly preferably not greater than 10 nm. When the average primary particle diameter is not greater than 20 nm, the absorbing property of reception layer 12 for the solvent of metal colloid solution 14 may be effectively improved and at the same time the smoothness of the surface of the layer may be increased.

The specific surface area of the inorganic fine particles as determined by the BET method is preferably not smaller than 200 m²/g, more preferably not smaller than 250 m²/g, and even more preferably not smaller than 380 m²/g. Inorganic fine particles having a specific surface area not smaller than 200 m²/g may provide reception layer 12 with high transparency.

The BET method in the present invention is one of the methods for measuring the surface area of powder by gas-phase adsorption, and more specifically it is a method for measuring the specific surface area, i.e., the total surface area per g of a sample, from the absorption isotherm. Nitrogen gas is commonly used as the adsorption gas, and most widely used is a method of determining the amount of adsorption by the change in pressure or volume of the adsorbed gas. One of the most famous equations describing the adsorption isotherm of multi-molecular system is the equation of Brunauer, Emmett, and Teller (BET equation). The surface area is calculated by multiplying the adsorption amount determined by the BET equation by the surface area occupied by a single adsorbed molecule.

Silica fine particles, in particular, have silanol groups on the surface thereof, and there is easy adhesion between the particles through the hydrogen bonding of the silanol groups, and due to an adhesion effect between the particles through the silanol groups and the water soluble resin, if the average primary size of the particles is not greater than 20 nm, the porosity ratio of reception layer 12 is high, and a structure having high transparency may be formed, whereby the absorbing property of reception layer 12 for the solvent of metal colloid solution 14 may be effectively improved.

Generally, Silica fine particles are largely classified into wet method particles and dry method (vapor phase process) particles depending on the manufacturing method. In the wet method, the silica particles are mainly produced by generating an activated silica by acid decomposition of a silicate, polymerizing the activated silica to a proper degree, and coagulating the resulting polymeric silica to give a hydrated silica. While, in the vapor phase process, anhydrous silica particles are mainly produced by high-temperature vapor phase hydrolysis of a silicon halide (flame hydrolysis process), or by reductively heating and vaporizing quartz and coke in an electric furnace by applying an arc discharge and then oxidizing the vaporized silica with air (arc method). The “vapor-phase process silica” refers to an anhydrous silica particle produced by a vapor phase process.

The vapor-phase process silica differs from hydrated silica in the density of silanol groups on the surface and the presence of voids therein, and exhibits different properties. The vapor-phase process silica is suitable for forming a three-dimensional structure having a higher void ratio. The reason for this is not clear, but it is presumed that, in the case of hydrated silica, fine particles have a high silanol group density of 5 to 8 silanol groups/nm² on the surface causing silica particles to coagulate densely (aggregate), while in the vapor phase process silica, fine particles have a low silanol group density of 2 to 3 silanol groups/nm² on the surface causing silica fine particles to coagulate sparsely (flocculate), leading to a structure having a higher void rate.

In the present invention, the vapor-phase process silica particles (anhydrous silica) obtained by the dry method is preferable, and silica particles having a silanol group density of 2 to 3 silanol groups/nm² is more preferable.

The inorganic fine particles favorably used in the present invention are those of a vapor-phase process silica having a BET specific surface area not smaller than 200 m²/g.

### <Polyvinyl Alcohol>

Polyvinyl alcohols used in the present invention have a saponification value of 92 to 98 mol % (hereinafter, also referred to as “polyvinyl alcohol according to the present invention”). A polyvinyl alcohol having a saponification value lower than 82 mol % causes the viscosity of the coating solution (functional fluid including the reception layer material) to be increased, thereby decreasing coating stability. In such a case, it is necessary to adjust the viscosity by adding methanol, ethanol, acetone, or the like. On the other hand, a polyvinyl alcohol having a saponification value greater than 98 mol % causes the absorption property for the solvent of metal collidal solution 14 to be decreased. A more preferable value of saponification is in the range from 93 to 97 mol %.

Preferably, the polymerization degree of the polyvinyl alcohol of the present invention is in the range from 1,500 to 3,600, more preferably in the range from 2,000 to 3,500. A polyvinyl alcohol having a polymerization degree smaller than 1,500 causes cracking in reception layer 12. While a polymerization degree greater than 4,000 causes the viscosity of coating solution (functional fluid including the reception layer material) to be increased which is undesirable.

In the present invention, a water-soluble resin other than the polyvinyl alcohol may be used in combination with the polyvinyl alcohol. Examples of the water-soluble resins for use in combination with the polyvinyl alcohol include polyvinyl alcohols (PVAs) having a hydroxyl group as a hydrophilic structural unit and a saponification value outside of the range described above, cationic-modified polyvinyl alcohols, anionic-modified polyvinyl alcohols, silanol-modified polyvinyl alcohols, polyvinylacetal, cellulosic resins (methylcellulose (MC), ethylcellulose (EC), hydroxyethylcellulose (HEC), carboxymethylcellulose (CMC), hydroxypropylcellulose (HPC), etc.), chitins, chitosans, and starch; hydrophilic ether bond-containing resins such as polyethylene oxide (PEO), polypropylene oxide (PPO), polyethylene glycol (PEG), and polyvinylether (PVE); hydrophilic amide group- or amide bond-containing resins such as polyacrylamide (PAAM) and polyvinyl pyrrolidone (PVP); and the like. Other examples include compounds having a carboxyl group as a dissociative group such as polyacrylate salts, maleic acid resins, alginate salts, gelatins, and the like.

Preferably, when the polyvinyl alcohol of the present invention is used in combination with the water-soluble resin described above, the ratio of the polyvinyl alcohol of the present invention to the total amount of the polyvinyl alcohol of the present invention and the water-soluble resin is in the range from 1 to 30 wt %, more preferably in the range from 3 to 20 wt %, and further preferably in the range from 6 to 12 wt %.

Preferably, the content of the polyvinyl alcohol of the present invention is in the range from 9 to 40 mass %, more preferably in the range from 12 to 33 mass % with respect to the total solid mass forming reception layer 12 from the viewpoint of preventing reduced film strength or cracking when the layer is dried due to shortage of the resin and preventing reduced absorption capacity due to blocking of voids by the resin due to an excessive amount of the resin.

The polyvinyl alcohol resins contain a hydroxyl group as a structural unit. Hydrogen bonding between the hydroxyl groups and the surface silanol groups on silica fine particles allows the silica fine particles to form a three-dimensional network structure having secondary particles as the network chain units. This three-dimensional network structure so constructed seems to be the cause of easier development of reception layer 12 having a porous structure having a higher void ratio.

In base material 10, porous reception layer 12 formed in the manner as described above rapidly absorbs the solvent of metal colloid solution 14 by the capillary phenomenon and may form true circular dots of metal colloid solution 14 without bleeding.

### <Content Ratio Between Inorganic Fine Particles and Polyvinyl Alcohol of the Present Invention>

When inorganic fine particles (preferably, silica fine particles; x) is used in combination with the polyvinyl alcohol of the present invention (if a water-soluble resin is used in combination with the polyvinyl alcohol, the total mass thereof; y), the content ratio between them [PB ratio (x/y), mass of inorganic fine particles relative to 1 part by mass of polyvinyl alcohol of the present invention] has great impact on the film structure of reception layer 12. That is, as the PB ratio increases, so do the void ratio, pore volume, and surface area (per unit mass). More specifically, it is preferable that the PB ratio (x/y) is 1.5/1 to 10/1 from the viewpoint of preventing reduced film strength and cracking when the layer is dried due to an extremely large PB ratio or preventing reduced absorption capacity for the solvent of metal colloid solution 14 arising from a decreased void ratio by the filling of voids with the resign due to an extremely small PB ratio.

When conveyed through a conveyer system of an ink jet printer, base material 10 having reception layer 12 formed thereon may be stressed, it is therefore necessary that reception layer 12 has a sufficient film strength. Further, from the viewpoint of preventing reception layer 12 from cracking, peeling, or the like when cut into a sheet, reception layer 12 needs to have a sufficient film strength. From such viewpoint, it is preferable that the PB ratio (x/y) is not greater than 5/1, and from the viewpoint of securing rapid absorption property of reception layer 12 for the solvent of metal colloid solution 14, it is preferable that the PB radio is not smaller than 2/1.

For example, when a coating solution (functional fluid including the reception layer material) prepared by homogeneously dispersing anhydrous silica fine particles having an average primary particle diameter of not greater than 20 nm and polyvinyl alcohol of the present invention in an aqueous solution at a PB ratio (x/y) in the range from 2/1 to 5/1 is applied on base material 10 and reception layer 12 is dried, a three-dimensional network structure having the secondary particles of silica fine particles as the network chains is formed and a transparent porous film with an average pore diameter of not greater than 30 nm, a void ratio in the range from 50 to 80%, specific pore volume of not smaller than 0.5 ml/g, and a specific surface area of not smaller than 100 m²/g is formed easily.

### <Cross-Linking Agent>

Reception layer 12 of the present invention includes a cross-linking agent. Preferably, reception layer 12 of the present invention is a porous layer of the polyvinyl alcohol of the present invention and the water-soluble resin used as required hardened by the cross-linking reaction of the cross-linking agent.

The cross-linking agent may be appropriately selected in relation to the polyvinyl alcohol of the present invention and water-soluble resin, used as required, included in reception layer 12. In particular, boron compounds are preferable in that they cause a faster cross-linking reaction. Examples of the boron compounds include borax, boric acid, borate salts (e.g., orthoborate salts, InBO₃, ScBO₃, YBO₃, LaBO₃, Mg₃(BO₃)₂ and CO₃(BO₃)₂) diborate salts (e.g., Mg₂B₂O₅, and CO₂B₂O₅), metaborate salts (e.g., LiBO₂, Ca(BO₂)₂, NaBO₂, and KBO₂), tetraborate salts (e.g., Na₂B₄O₇.10H₂O) pentaborate salts (e.g., KB₅O₈.4H₂O, Ca₂B₆O₁₁.7H₂O, and CsB₅O₅), and the like. Among them, borax, boric acid and borates are preferable since they are able to promptly cause a cross-linking reaction. Particularly, boric acid or borate salt is preferable, and the combined use of the boric acid or borate salt and polyvinyl alcohol, a water-soluble resin, is most preferable.

Preferably, in the present invention, the cross-linking agent is included in an amount of 0.05 to 0.50 parts by weight relative to 1 part by weight of the polyvinyl alcohol of the present invention, and more preferably in an amount of 0.08 to 0.30 parts by weight. If the content of the cross-linking agent is within the ranges, the polyvinyl alcohol of the present invention may be effectively cross-linked, whereby cracking and the like may be prevented.

When gelatin is used as a water-soluble resin, the following compounds other than the boron compounds may be used as the cross-linking agents.

Examples of such cross-linking agents include: aldehyde compounds, such as formaldehyde, glyoxal and glutaraldehyde; ketone compounds, such as diacetyl and cyclopentanedione; active halogen compounds, such as bis(2-chloroethylurea)-2-hydroxy-4,6-dichloro-1,3,5-triazine and 2,4-dichloro-6-S-triazine sodium salt; active vinyl compounds, such as divinyl sulfonic acid, 1,3-vinylsulfonyl-2-propanol, N,N′-ethylenebis (vinylsulfonylacetamide) and 1,3,5-triacryloyl-hexahydro-S-triazine; N-methylol compounds such as dimethylolurea and methylol dimethylhydantoin; melamine resin such as methylolmelamine and alkylated methylolmelamine; epoxy resins; isocyanate compounds, such as 1,6-hexamethylenediisocyanate, aziridine compounds such as those described in U.S. Pat. Nos. 3,017,280 and 2,983,611; carboxyimide compounds such as those described in U.S. Pat. No. 3,100,704; epoxy compounds, such as glycerol triglycidyl ether; ethyleneimino compounds such as 1,6-hexamethylene-N,N′-bisethylene urea; halogenated carboxyaldehyde compounds, such as mucochloric acid and mucophenoxychloric acid; dioxane compounds, such as 2,3-dihydroxydioxane; metal-containing compounds, such as titanium lactate, aluminum sulfate, chromium alum, potassium alum, zirconyl acetate and chromium acetate; polyamine compounds, such as tetraethylene pentamine; hydrazide compounds, such as adipic acid dihydrazide; and low molecular compounds or polymers including at least two oxazoline groups. These cross-linking agents may be used solely or in combination with one or more of other compounds.

### <Water-Soluble Aluminum Compound>

Reception layer 12 of the present invention includes a water-soluble aluminum compound. The use of a water-soluble aluminum compound may improve the water resistance and temporal bleeding resistance of a conductive pattern formed. Further, the use of a aluminum hydroxide compound may reduce the sintering temperature of the conductive pattern. The mechanism of this is uncertain, but it is thought that the water-soluble aluminum oxide interacts with the metal colloid particle dispersant and the adsorption equilibrium of the dispersant to the metal colloid particles is lost, whereby the dispersant breaks away from the particles.

Examples of the water-soluble aluminum compounds include inorganic salts, such as aluminum chloride or the hydrates thereof, aluminum sulfate or the hydrates thereof, ammonium alum, and the like. Other examples include inorganic aluminum-containing cationic polymers, such as basic polyaluminum hydroxide compounds. Among them, basic polyaluminum hydroxide compounds are preferable.

The basic polyaluminum hydroxide compounds are water soluble polyaluminum hydroxide compounds stably including multi-nucleated condensate ions of basic polymers, such as [Al₆(OH)₁₅]³⁺, [Al₈(OH)₂₀]⁴⁺, [Al₁₃(OH)₃₄]⁵⁺, [Al₂₁OH)₆₀]³⁺, and the major components thereof are represented by the following formulae.

[Al₂(OH)ₙCl₆₋ₙ]ₘ5<m<80,1<n<5 Formula 1

[Al(OH)₃]ₙAlCl₃1<n<2 Formula 2

Alₙ(OH)ₘCl₍₃ₙ₋ₘ₎0<m<3n,5<m<8 Formula 3

These compounds of various grades are put on the market and may easily be obtained from Taki Chemical Co. Ltd. in the name of polyaluminum chloride (PAC), as water treatment agents, Asada Kagaku Co. Ltd. in the name of polyhydrated aluminium (Paho), Rikengreen Co. Ltd., in the name of pyurakem WT, Taimei Chemicals Co. Ltd., in the mane of alphaine 83, and other manufacturers with the same purpose. These commercially available products may be used directly in the present invention, but some of the products may have inappropriately low pH values and in such a case the pH may be adjusted appropriately before used.

Preferably, the content of the water-soluble aluminum compound in reception layer 12 of the present invention is in the range from 0.1 to 20 mass %, more preferably in the range from 1 to 15 mass %, and most preferably in the range from 2 to 15 mass % with respect to the total solid mass forming reception layer 12. The content of water-soluble aluminum compound in the range from 2 to 15 mass % may improve the smoothness, in addition to an advantageous effect of a reduced sintering temperature.

### <Zirconium Compound>

Reception layer 12 of the present invention includes a zirconium compound. The use of a zirconium compound may provide an advantageous effect of an improved water resistance.

There is not any specific restriction on the zirconium compounds for use in the present invention, and various compounds may be use including, for example, zirconyl acetate, zirconium chloride, zirconium oxychloride, zirconium hydroxychloride, zirconium nitrate, basic zirconium carbonate, zirconium hydroxide, zirconium ammonium carbonate, zirconium potassium carbonate, zirconium sulfate, zirconium fluoride compound, and the like. Among them, zirconyl acetate is particularly preferable.

Preferably, the content of the zirconium compound in reception layer 12 of the present invention is in the range from 0.05 to 5.0 mass %, more preferably in the range from 0.1 to 3 mass %, and particularly preferably in the range from 0.5 to 2.0 mass % with respect to the total solid mass forming reception layer 12. The content of zirconium compound in the range from 0.5 to 2.0 mass % may improve water resistance without degrading absorption property.

In the present invention, a water-soluble polyvalent metal compound other than the water-soluble aluminum compound and zirconium compound described above may also be used. Examples of the other water-soluble polyvalent metal compounds include water-soluble salts of a metal selected from calcium, barium, manganese, copper, cobalt, nickel, iron, zinc, chromium, magnesium, tungsten, and molybdenum.

Typical examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, ammonium copper (II) chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, ferrous bromide, ferrous chloride, ferric chloride, ferrous sulfate, ferric sulfate, zinc bromide, zinc chloride, zinc nitrate hexahydrate, zinc sulfate, chromium acetate, chromium sulfate, magnesium sulfate, magnesium chloride hexahydrate, magnesium citrate nonahydrate, sodium phosphotungstate, sodium tungsten citrate, dodecatungstophosphoric acid n-hydrate, dodecatungstosilicic acid 26-hydrate, molybdenum chloride, dodecamolybdophosphoric acid n-hydrate, and the like.

### <Other Components>

Reception layer 12 of the present invention may include the following components as required.

Examples of ultraviolet absorbers include cinnamic acid derivatives, benzophenone derivatives and benzotriazolyl phenol derivatives. Specific examples include α-cyano-phenyl cinnamic acid butyl ester, o-benzotriazole phenol, o-benzotriazole-p-chlorophenol, o-benzotriazole-2,4-di-t-butyl phenol, o-benzotriazole-2,4-di-t-octyl phenol. A hindered phenol compound amy also be used as an ultraviolet absorber, and phenol derivatives in which at least one or more of the second place and/or the sixth place is substituted by a branching alkyl group is preferable.

A benzotriazole based ultraviolet absorber, a salicylic acid based ultraviolet absorber, a cyano acrylate based ultraviolet absorber, and oxalic acid anilide based ultraviolet absorber or the like can be also used. Such ultraviolet absorbers are described, for example, in the following patent documents: Japanese Unexamined Patent Publication Nos. 47 (1972)-010537, 58 (1983)-111942, 58 (1983)-212844, 59 (1984)-019945, 59 (1984)-046646, 59 (1984)-109055, and 63 (1988)-053544, Japanese Patent Publication Nos. 36 (1961)-010466, 42 (1967)-026187, 48 (1973)-030492, 48 (1973)-031255, 48 (1973)-041572, 48 (1973)-054965, and 50 (1975)-010726, U.S. Pat. Nos. 2,719,086, 3,707,375, 3,754,919, and 4,220,711.

An optical whitening agent may also be used as an ultraviolet absorber, and specific examples include a coumalin based optical whitening agent. Specific examples are described in Japanese Patent Nos. 45 (1970)-004699 and 54 (1979)-005324, and the like

Examples of antioxidants are described in European Patent Publication Nos. 223739, 309401, 309402, 310551, 310552, and 459-416, German Patent Publication No. 3435443, Japanese Unexamined Patent Publication Nos. 54 (1979)-048535, 60 (1985)-107384, 60 (1985)-107383, 60 (1985)-125470, 60 (1985)-125471, 60 (1985)-125472, 60 (1985)-287485, 60 (1985)-287486, 60 (1985)-287487, 60 (1985)-287488, 61 (1986)-160287, 61 (1986)-185483, 61 (1986)-211079, 62 (1987)-146678, 62 (1987)-146680, 62 (1987)-146679, 62 (1987)-282885, 62 (1987)-262047, 63 (1988)-051174, 63 (1988)-089877, 63 (1988)-088380, 66 (1991)-088381, 63 (1988)-113536, 63 (1988)-163351, 63 (1988)-203372, 63 (1988)-224989, 63 (1988)-251282, 63 (1988)-267594, 63 (1988)-182484, 1 (1989)-239282, 2 (1990)-262654, 2 (1990)-071262, 3 (1991)-121449, 4 (1992)-291685, 4 (1992)-291684, 5 (1993)-061166, 5 (1993)-119449, 5 (1993)-188687, 5 (1993)-188686, 5 (1993)-110490, 5 (1993)-1108437, and 5 (1993)-170361, and Japanese Patent Publication Nos. 48 (1973)-043295 and 48 (1973)-033212, and U.S. Pat. Nos. 4,814,262 and 4,980,275.

Specific examples of the antioxidants include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4-tetrahydroquinoline, nickel cyclohexanoate, 2,2-bis(4-hydroxyphenyl) propane, 1,1-bis(4-hydroxyphenyl)-2-ethylhexane, 2-methyl-4-methoxy-diphenylamine, 1-methyl-2-phenyl indole, and the like.

These antioxidants can be used solely or in combination with one or more of other compounds. The antioxidants may be dissolved in water, dispersed, emulsified, or they may be included in microcapsules. Preferably, the amount of antioxidant added is in the range from 0.01 to 10% by mass relative to the total amount of the coating solution for forming the reception layer.

Preferably, in the present invention, reception layer 12 includes an organic solvent with a high boiling point so that curling is prevented. For the high boiling point organic solvent, water soluble solvents are preferably used. Examples of such water soluble organic solvents with a high boiling point include the following alcohols. Namely, ethylene glycol, propylene glycol, diethylene glycol, triethylene glycol, glycerin, diethylene glycol monobutylether (DEGMBE), triethylene glycol monobutyl ether, glycerin monomethyl ether, 1,2,3-butane triol, 1,2,4-butane triol, 1,2,4-pentane triol, 1,2,6-hexane triol, thiodiglycol, triethanolamine, polyethylene glycol (average molecular weight of not greater than 400). Among them, diethylene glycol monobutylether (DEGMBE) is preferable.

Preferably, the content of the high boiling point organic solvent in the reception layer coating solution is in the range from 0.05 to 1% by mass, and particularly preferable in the range from 0.1 to 0.6% by mass.

Further, various types of inorganic salts may be included in order to increase the dispersability of the inorganic fine particles, and acids or alkalis may be included for pH adjustment.

Still further, conductive metal oxide fine particles having an electron conductivity, for preventing frictional electrification and peeling electrification, and various types of matting agents, for reducing the surface friction, may be included to the extent that does not impair the electrical characteristics as a printed wiring board.

A method for forming reception layer 12 using a reception layer material will now be described in further detail.

An example method for forming reception layer 12 of the present invention includes at least the following steps of: preparing a dispersion solution by dispersing inorganic fine particles and a zirconium compound by counter-colliding them using a high pressure disperser or passing them through an orifice; preparing a reception layer forming solution by adding a cationic-modified self-emulsifying polymer, a polyvinyl alcohol having a saponification value of 82 to 98 mol %, and a cross-linking agent to the dispersion solution; and forming reception layer 12 by applying a coating solution (functional fluid including the reception layer material), obtained by in-line mixing a water soluble aluminum compound with the reception layer forming solution, on a base material 10.

Another method for forming reception layer 12 of the present invention includes at least the following steps of: preparing a dispersion solution by dispersing inorganic fine particles, a zirconium compound, and a cross-linking agent by counter-colliding them using a high pressure disperser or passing them through an orifice; preparing a reception layer forming solution by adding a cationic-modified self-emulsifying polymer and a polyvinyl alcohol having a saponification value of 82 to 98 mol % to the dispersion solution; and forming reception layer 12 by applying a coating solution (functional fluid including the reception layer material), obtained by in-line mixing a water soluble aluminum compound with the reception layer forming solution, on a base material 10.

Each of the methods described above is superior in that it is able to provide a dispersion solution with inorganic fine particles having a small particle diameter by counter-colliding the inorganic fine particles and ziruconium compound or the inorganic fine particles, ziruconium compound, and cross-linking agent using a high pressure disperser or passing them through an orifice.

The mixture of inorganic fine particles and ziruconium compound or the inorganic fine particles, ziruconium compound, and cross-linking agent is fed into a high pressure disperser in the state of a dispersion solution including the mixture (preliminary dispersion solution). Preliminary mixing (preliminary dispersion) may be performed by an ordinary propeller agitator, turbine agitator, homomixer agitator, or the like.

As for the high pressure disperser used for preparing the dispersion solution, commercially available dispersers generally called as a high pressure homogenizer are preferably used.

Typical high pressure homogenizers include Nanomizer (trade name, manufactured by Nanomizer), Microfluidizer (trade name, manufactured by Microfluidex Inc.), Ultimizer (manufactured by Sugino Machine Ltd.), and the like.

The term “orifice” as used herein refers to a mechanism of restricting flow path of a straight pipe by inserting a thin plate with fine holes having a circular or another geometrical shape (orifice plate) into the pipe.

Basically, the high pressure homogenizer is an apparatus that includes a high pressure generation unit for pressurizing material slurry and the like and a counter-collision or orifice unit. high pressure pumps generally known as a plunger pump are preferably used in the high pressure generation unit. Various types of high-pressure pumps are available, such as single pump type, twin pump type, triple pump type, and the like, and any type may be used in the present invention.

Preferably, the processing pressure when performing the high pressure counter collision is not less than 50 MPa, more preferably not less than 100 MPa, and further preferably not less than 130 MPa.

Preferably, the pressure difference between the inlet and outlet of the orifice when passing the mixture is not less than 50 MPa, more preferably not less than 100 MPa, and further preferably not less than 130 MPa, as in the processing pressure described above.

Preferably, when counter colliding, the collision speed of the preliminary dispersion solution, as the relative velocity, is not less than 50 m/sec, more preferably not less than 100 m/sec, and further preferably not less than 150 m/sec.

The linear velocity of a solvent passing through the orifice may vary according to the pore size of the orifice used, but preferably not less than 50 m/sec, more preferably not less than 100 m/sec, and further preferably not less than 150 m/sec, as in the collision speed at the time of counter collision.

In any of the methods described above, the dispersion efficiency depends on the processing pressure, and as the processing pressure increases so does the dispersion efficiency. A processing pressure exceeding 350 MPa, however, tends to cause a pressure resistance problem in the piping of the high pressure pump and a durability problem of the apparatus.

In any one of the methods described above, there is not any specific limitation on the number of processing times and normally it is selected from the range of one to dozens of times. In this way, the dispersion solution may be obtained.

When preparing the dispersion solution, a variety of additives may be added.

Examples of the additives include various types of nonionic or cationic surfactants (anionic surfactants are undesirable because they form aggregation substances), antifoams, nonionic hydrophilic polymers (polyvinyl alcohol, polyvinyl pyrrolidone, polyethyleneoxide, polyacrylamide, various sugars, gelatin, pullulan, and the like), nonionic or cationic latex dispersion solution, water-miscible organic solvents (ethyl acetate, methanol, ethanol, isopropanol, n-propanol, acetone, etc.), inorganic salts, pH adjusters, and the like, which may used as required.

Water-miscible organic solvents, in particular, are preferable in that they are able to preventing the formation of microaggregations when inorganic fine particles (silica) are preliminarily dispersed. Preferably, the content of water-miscible organic solvent in the dispersion solution is in the range from 0.1 to 20 mass %, and more preferably in the range from 0.5 to 10 mass %.

The pH when preparing an inorganic fine particle (gas-phase silica) dispersion solution may vary largely according to the type of the inorganic fine particles (gas-phase silica) used and various additives used. Generally, however, it is in the range from 1 to 8, and particularly preferably in the range from 2 to 7. Two or more additives may be used in the dispersion solution.

In the method for manufacturing reception layer 12 of the present invention, a reception layer forming solution is obtained by adding a cationic modified self-emulsifying polymer, a polyvinyl alcohol of the present invention, and the like to the dispersion solution obtained by the method described above. The mixing of the dispersion solution described above with the cationic modified self-emulsifying polymer, polyvinyl alcohol of the invention, and the like may be performed by an ordinary propeller agitator, turbine agitator, or homomixer agitator.

In the method for forming reception layer 12 of the present invention, an in-line mixer preferably used for in-line mixing the water soluble aluminum compound with the reception layer forming solution is described, for example, in Japanese Unexamined Patent Publication No. 2002-85948 but not limited to this.

The method for forming reception layer 12 of the present invention may further include a step of cross-linking and hardening reception layer 12 by applying a basic solution having a pH not less than 7.1 on reception layer 12 formed on a base material by applying the coating solution (functional fluid including the reception layer material) obtained by in-line mixing the water soluble aluminum compound with the reception layer forming solution either (1) when the coating solution (functional fluid including the reception layer material) is applied or (2) during drying step of reception layer 12 and before reception layer 12 exhibits decreasing drying.

Provision of cross-linked and hardened reception layer 12 in the manner as described above is preferable from the viewpoints of absorption property of reception layer 12 for the solvent of metal colloid solution 14 and prevention of cracking.

In the method for forming reception layer 12 of the present invention, water, organic solvent, or mixture thereof may be used as the solvent in each step. Examples of the organic solvents usable for the coating include alcohols such as methanol, ethanol, n-propanol, i-propanol, and methoxypropanol, ketones such as acetone and methylethylketone, tetrahydrofuran, acetonitrile, ethyl acetate, toluene, and the like.

The reception layer forming solution may be applied by known methods, such as extrusion die coater, air doctor coater, blade coater, rod coater, knife coater, squeeze coater, reverse roll coater, bar coater, inkjet, and the like.

A basic solution having a pH not less than 7.1 is applied to reception layer 12 simultaneously with the application of the reception layer forming solution or during a drying of reception layer 12 formed by applying the reception layer forming solution and before reception layer 12 exhibits a decreasing drying rate. That is, reception layer 12 is formed favorably by applying the basic solution having a pH not less than 7.1 on reception layer 12 while the layer shows a constant drying rate after the application of the reception layer forming solution.

The basic solution having a pH not less than 7.1 may include a cross-linking agent as required. The basic solution having a pH not less than 7.1 may facilitate hardening of the film when used as an alkali solution. Therefore, it is preferable that the basic solution has a pH not less than 7.5 and more preferably not less than 7.9. A pH closer to the acidic side may result in insufficient cross-linking reaction of the polyvinyl alcohol included in the reception layer forming solution by the cross-linking agent, causing problems such as bronzing, inducing defects, such as cracking, in reception layer 12.

The basic solution having a pH not less than 7.1 may be prepared, for example, by adding a metal compound (e.g., 1 to 5%) and a basic compound (e.g., 1 to 5%), and p-toluenesulfonic acid (e.g., 0.5 to 3%) as required, to ion-exchange water and agitating the mixture thoroughly. The above “%” for each component refers to solid content mass %.

The term “before reception layer 12 exhibits a decreasing drying rate” as used herein generally refers to a period of few minutes just after the application of the coating solution (functional fluid including the reception layer material). During the period, coated reception layer shows a phenomenon of “constant drying rate” in which the content of the solvent (dispersion medium) decreases linearly with time. The period of the “constant drying rate” is described, for example, in Chemical Engineering Handbook (pp. 707 to 712, published by Maruzen Co., Ltd., Oct. 25, 1980).

The reception layer forming solution is dried after being applied until reception layer 12 shows a decreasing drying rate as described above, which is generally implemented at a temperature in the range from 40 to 180° C. for 0.5 to 10 minutes (preferably for 0.5 to 5 minutes). The drying period, of course, varies according to the amount coated, but the range described above is generally appropriate.

Next, metal colloid solution 14 for forming conductive metal portion 16 will be described in detail.

There is not any specific restriction on metal colloid solution 14 of the present invention as long as metal colloidal particles are stabilized as a colloid solution by the presence of a dispersant.

Preferably, the metal colloidal particles included in metal colloid solution 14 are those obtained by reducing a metal compound under the presence of a polymer dispersant. The metal colloidal particles can be stably maintained as a metal colloidal particle solution by the polymer dispersant even in a high concentration state. Preferably, the metal concentration in the metal colloidal particle solution is as high as possible, and a preferable value is not less than 93% by mass and a more preferable value is not less than 95% by mass.

The term “metal concentration in the metal colloidal particle solution” as used herein refers to a mass % of the metal in the solid content of the metal colloidal particle solution. The solid content may be obtained by measuring a remaining amount after heating the solution at 140° C., and the amount of metal may be obtained by measuring a remaining amount after heating the solution at 500° C. More specifically, the temperature of the solution is increased to 140° C. at a rate of 10° C./min using a TG-DTA, and the solid content is obtained after maintaining the temperature at 140° C. for 30 minutes. Thereafter, the temperature is increased to 500° C. at a rate of 10° C./min and the amount of metal is obtained after maintaining the temperature at 500° C. for 30 minutes. The measurement of metal concentration described herein is performed using the method described above unless otherwise specifically described.

The metal compound, the source of the metal colloidal particles, is a compound that produces metal ions when dissolved in a solvent and metal colloidal particles are deposited by the reduction of the ions. There is not any specific restriction on the metal for forming metal colloidal particles, but a precious metal or copper is preferably used from the viewpoint of obtaining conductivity. There is not any specific restriction on the noble metal and, for example, gold, silver, ruthenium, rhodium, palladium, osmium, iridium, platinum, and the like may be cited. Among them, gold, silver, platinum, and palladium are preferable and silver is particularly preferable in that it has an excellent conductivity.

There is not any specific restriction on the metal compound as long as it includes a noble metal described above or copper. Examples of such metal compounds include hydrogen tetrachloroaurate(III) tetrahydrate (chlorauric acid), silver nitrate, silver acetate, silver perchlorate(IV), hexachloroplatinic (IV) acid hexahydrate (chloroplatinic acid), potassium chloroplatinate, copper(II) chloride dihydrate, cupric acetate monohydrate, copper(II) sulfate, palladium (II) chloride dihydrate, rhodium (III) trichloride trihydrate, and the like. Each of these compound may be used solely or in combination with one or more of other compounds.

Preferably, the metal compound is used such that the metal molar concentration in the solvent is not less than 0.01 mol/l. If the metal molar concentration is less than 0.01 mol/l, the metal molar concentration of metal colloidal particle solution is too low, resulting in inefficiency. Preferably, the metal molar concentration is not less than 0.05 mol/l and more preferably not less than 0.1 mol/l.

There is not any specific restriction on the solvent as long as it is capable of dissolving a metal compound. Typical examples may be water, organic solvents, and the like. There is not any specific restriction on the organic solvent, and examples include alcohols, such as methanol, ethanol, propanol, and butanol; ketones, such as acetone; esters, such as ethyl acetate; hydrocarbon system compounds, such as n-heptane, n-octane, decane, toluene, xylene, cymene, durene, indene, dipentene, tetrahydronaphthalene, decahydronaphthalene, and cyclohexylbenzene; ether system compounds, such as ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, 1,2-dimethoxyethane, bis(2-methoxyethyl)ether, and p-dioxane; polar compounds, such as propylene carbonate, γ-butyrolactone, N-methyl-2-pyrrolidone, dimethylformamide, dimethyl sulfoxide, and cyclohexanone; apolar compounds or low polarity compounds, such as terpineol, mineral spirit, xylene, toluene, tetradecane, dodecane, and 1-decanol which is a primary alcohol. Each of the compounds may be used solely or in combination with one or more of other compounds. When the solvent is a mixture of water and an organic solvent, a water soluble organic solvent is preferably used. Such organic solvents include, for example, acetone, methanol, ethanol, and ethylene glycol. Among them, water, alcohol, and a mixture of water and alcohol are preferably used as they are suitable for ultrafiltration performed in a later condensation process. It is also preferable to use a solvent having a relatively high boiling point not causing evaporation around room temperature.

The solvent of metal colloid solution 14 may be determined in view of the compatibility with the solvent of coagulant solution 20 and difference in SP (solubility parameter) value. Decision of the solvents of metal colloid solution 14 and coagulant solution 20 will be described later.

In the mean time, as for the polymer dispersant, it is preferable to use a amphiphilic copolymer having a structure which includes a asolvated portion and a functional group highly compatible with the surface of the metal colloidal particles is introduced in a high molecular weight polymer.

Such polymer dispersants are those generally used as a dispersant when manufacturing a paste, and normally having a number average molecular weight in the range from 1,000 to 1,000,000. When the number average molecular weight is less than 1,000, insufficient dispersion stability may result, while if it exceeds 1,000,000, an excessively high viscosity may result, causing it difficult to handle. Preferably, the number average molecular weight is in the range from 2,000 to 500,000 and more preferably in the range from 4,000 to 500,000.

There is not any specific restriction on the polymer dispersant as long as it has the property described above and, for example, those described in Japanese Unexamined Patent Publication No. 11 (1999) -080647. Various types of polymer dispersants may be used and those available in the market may also be used. Commercially available products include, for example, Solsperse 20000, Solsperse 24000, Solsperse 26000, Solsperse 27000, Solsperse 28000, and Solsperse 41090 (manufactured by Avecia Limited), Disperbyk 160, Disperbyk 161, Disperbyk 162, Disperbyk 163, Disperbyk 166, Disperbyk 170, Disperbyk 180, Disperbyk 181, Disperbyk 182, Disperbyk 183, Disperbyk 184, Disperbyk 190, Disperbyk 191, Disperbyk 192, Disperbyk-2000, and Disperbyk-2001 (manufactured by Big Chemy), Polymer 100, Polymer 120, Polymer 150, Polymer 400, Polymer 401, Polymer 402, Polymer 403, Polymer 450, Polymer 451, Polymer 452, Polymer 453, EFKA-46, EFKA-47, EFKA-48, EFKA-49, EFKA-1501, EFKA-1502, EFKA-4540, and EFKA-4550 (manufactured by EFKA Chemicals), FLOREN DOPA-158, FLOREN DOPA-22, FLOREN DOPA-17, FLOREN G-700, FLOREN TG-720W, FLOREN-730W, FLOREN-740W, and FLOREN-745W (manufactured by Kyoeisha Chemical Co.), Ajisper PA111, Ajisper PB711, Ajisper PB811, Ajisper PB821, and Ajisper PW911 (manufactured by AJINOMOTO CO., INC.), Joncryl 678, Joncryl 679, and Joncryl 62 (manufactured by Johnson Polymer Co., Ltd.), and the like. Each of these agents may be used solely or in combination with one or more of other agents.

Preferably, the amount of polymer dispersant used is 10 mass % with respect to the total amount of the metal in a metal compound and polymer dispersant. If the amount exceeds 10 mass %, there may be a case in which the metal concentration in the solid content of a solution will not be increased to a desired value when ultrafiltration is performed at a later time. Amore preferable value for the amount of polymer dispersant used is not greater than 8 mass %, and a further preferable value is not greater than 7 mass %.

The metal compound may be reduced using a reducing compound. As for the reducing compound, amines are preferably used. For example, if a solution of metal compound and polymer dispersant is agitated/mixed after adding an amine, metal ions are reduced to metal. Use of amines eliminates the need to use dangerous or poisonous reductants and allows metal compounds to be reduced at a reaction temperature in the range from 5 to 100° C., more preferably in the range from 20 to 80° C. without requiring any special heating or light emission device.

There is not any specific restriction on the amine and, for example, those described in Japanese Unexamined Patent Publication No. 11 (1999) -080647 may be used. Further, aliphatic amines, such as propylamine, butylamine, hexylamine, diethylamine, dipropylamine, dimethylethylamine, diethylmethylamine, triethylamine, ethylenediamine, N,N,N′,N′-tetramethyl ethylene diamine, 1,3-diaminopropane, N,N,N′,N′-tetramethyl-1,3-diaminopropane, triethylenetetramine, and tetraethylene pentamine; alicyclic amines, such as piperidine, N-methylpiperidine, piperazine, N,N′-dimethylpiperazine, pyrrolidine, N-methylpyrrolidine, and morpholine; aromatic amines, such as aniline, N-methylaniline, N,N′-dimethylaniline, toluidine, anisidine, and phenetidine; aralkylamines, such as benzylamine, N-methylbenzylamine, N,N-dimethylbenzylamine, phenethylamine, xylylenediaimine, and N,N,N′,N′-tetramethylxylylenediamine. In addition, alkanolamines, such as methylaminoethanol, dimethylaminoethanol, triethanolamine, ethanolamine, diethanolamine, methyldiethanolamine, propanolamine, 2-(3-aminopropylamino) ethanol, butanolamine, hexanolamine, dimethylamino propanol, and the like may also be cited. Each of the compounds may be used solely or in combination with one or more of other compounds. Among them, alkanolamines are preferable and dimethylaminoethanols are more preferable.

In addition to the amines, compounds known as reductants, such as alkali metal borohydride salts including sodium borohydride and the like, hydrazine compounds, citric acids, acidum tartaricums, ascorbic acids, formic acids, formaldehydes, dithionous acids, sulfoxylate derivatives, and the like may also be used. Among them, citric acid, acidum tartaricums, and ascorbic acids are preferably used as they are easily obtainable. Each of the compounds may be used solely or in combination with an amine. When a citric acid, an acidum tartaricum, or an ascorbic acid is used in combination with an amine, it is preferable that the citric acid, acidum tartaricum, or ascorbic acid is in the form of salt. Further, the reducibility of citric acid or sulfoxylate derivative may be improved through combined use with iron (II) ions.

Preferably, the additive amount of the reducing compound is an amount necessary to reduce the metal in a metal compound or more. The lesser amount than this may result in insufficient reduction. There is not a specific upper limit for the amount, but preferably not greater than 30 times, and more preferably not greater than 10 times of the amount necessary to reduce the metal in a metal compound. Further, a method in which the reduction is induced by emitting light using a high-pressure mercury vapor lamp may also be used other than the chemical reduction method using the reducing compounds described above.

There is not any specific restriction on the method of adding a reducing compound. For example, a reducing compound may be added after a polymer dispersant. In this case, for example, the polymer dispersant is dissolved in a solvent first, then either the reducing compound or a metal compound is dissolved to obtain a solution, and finally either the reducing compound or metal compound remaining is added to the solution, whereby the reduction process may progress. Alternatively, the polymer dispersant and reducing compound may be mixed together first, then the mixture may be added to a solution of the metal compound.

Through the reduction, a solution that includes metal colloidal particles with an average particle diameter of 5 to 100 nm may be obtained. The solution includes the metal colloidal particles and polymer dispersant described above. The term “metal colloidal particle solution” as used herein refers to a solvent in which fine metal particles are dispersed and is visually recognizable as a solution. The metal concentration of metal colloidal particle solution obtained in the manufacturing process may be determined by performing measurement with a TG-DTA or the like as described above. Where such measurement is not performed, a value calculated from the blending amounts used in the preparation may be used.

Next, the reduced solution may be ultrafiltrated. The reduced metal colloidal particle solution includes miscellaneous ions, such as chloride ions and the like derived from the materials and impurities, such as salts produced by the reduction, amine, and the like, as well as metal colloidal particles and polymer dispersant. These impurities may adversely influence the stability of metal colloidal solution 14, and therefore it is desirable to remove them. For the removal of impurities, electrodialytic separation method, centrifugal separation method, ultrafiltration method, or the like may be used. The ultrafiltration method, in particular, may condense the solution by partly removing the polymer dispersant, as well as removing impurities, whereby the metal concentration may be increased.

Preferably, the solid content formed of metal colloidal particles and polymer dispersant included in metal colloid solution 14 is in the range from 0.05 to 50% by mass. If the solid content is less than 0.05%, the metal molar concentration is too low to perform efficient ultrafiltration, while if it exceeds 50%, removal of impurities may become difficult.

Generally, the diameter of a separation target substance for ultrafiltration is in the range from 1 nm to 5 μm. With the diameter as the target, the ultrafiltration may remove a portion of the polymer dispersant together with impurities, whereby the metal concentration of metal colloidal particles obtained may be increased. If the diameter is less than 1 nm, an unnecessary component, such as an impurity and the like, may remain without passing throught the filtration membrane, while if it exceeds 5 μm, most of metal colloidal particles may pass through the filtration membrane and high concentration metal colloidal particles may not be obtained.

There is not any specific restriction on the filtration membrane of the ultrafiltration and generally resin membranes, such as polyacrylonitrile, vinyl chloride/acrylonitrile copolymer, polysulfone, polyimide, polyamide, and the like, are used. Among them, polyacrylonitrile and polysulfone are preferable, and polyacrylonitrile is more preferable. From the viewpoint of efficient cleaning of filtration membrane generally performed after ultrafiltration, a filtration membrane that can be reversely cleaned is preferably used.

Preferably, the filtration membrane of the ultrafiltration is a membrane having a molecular weight cut off in the range from 3,000 to 80,000. If the molecular weight cut off is less than 3,000, the unnecessary polymer dispersant or the like is difficult to be removed sufficiently, while if it exceeds 80,000, the filtration membrane allows easy passage and desired metal colloidal particles may not be obtained. A more preferable value of the molecular weight cut off is in the range from 10,000 to 60,000. The term “molecular weight cut off” generally refers to the molecular mass of a polymer molecule removed to the outside through a pore of an ultrafiltration membrane when a polymer solution is passed through the ultrafiltration membrane. The molecular weight cut off is used to evaluate the pore diameter of a filtration membrane in which the pore diameter increases as the value increases.

There is not any specific restriction on the type of filtration module of the ultrafiltration. Filtration modules are classified, for example, into hollow fiber module (also called as “capillary module”), spiral module, tubular module, and plate type module and any of them may be used in the present invention. Among them, the hollow fiber module is preferably used from the viewpoint of efficiency, i.e., a large filtration area with a compact size. Where a large amount of metal colloidal particle solution is processed, it is preferable to use a filtration module having a large number of ultrafiltration membranes.

There is not any specific restriction on the ultrafiltration method, and a metal colloidal particle solution obtained by reducing a metal compound is passed through an ultrafiltration membrane by any known method. This discharges the filtrate that includes the impurities and polymer dispersant described above. Generally, the ultrafiltration is repeated until the concentration of miscellaneous ions in a filtrate becomes a desired level. Here, in order to maintain the concentration of the metal colloidal particle solution to be processed at a constant value, it is preferable that an amount of solvent corresponding to that of the discharged filtrate is added to the solution. Here, it is possible to replace the solvent of the metal colloidal particle solution by using a solvent different from that used at the time of reduction as the solvent to be added at this time.

The ultrafiltration may be implemented through an ordinary operation, for example, by a so-called batch method. The batch method is a method in which the metal colloidal particle solution is added as the ultrafiltration progresses. Note that the ultrafiltration may further be repeated after the concentration of miscellaneous ions falls blow a desired level in order to increase the solid content concentration.

The metal colloidal particle solution obtained in the manner as described above is adjusted so as to become suitable for an inkjet method, whereby the solution is turned into metal colloid solution 14. Generally, a water soluble resin, such as glycerin, maltitol, or carboxymethyl cellulose, an ethylene glycol, a surfactant, a pH adjuster, a chelating agent, a binder, a surface tension modifier, and a plasticizer are added for the purposes of adjusting viscosity, improving dispersion, improving penetration into reception layer 12 and preventing dring of nozzle. Further, a fungicide, an antiseptic agent, a humectant, an evaporation accelerator, an antifoam agent, an antioxidant, a light stabilizer, an anti-deterioration agent, an oxygen absorber, a corrosion inhibitor, or the like may also be added as required.

The metal content in metal colloid solution 14, component content used for the adjustment, and viscosity of the solution may be set to 2 to 50 wt %, 0.3 to 30 wt %, and 3 to 30 centipoise respectively.

An embodiment in which metal colloid solution 14 is produced by a liquid phase reduction method has been described. But the present invention is not limited to this, and metal colloid solution 14 produced by a so-called gas phase method may also be used. For example, a metal colloid solution commercially available from Harima Chemicals, Inc. under the name of NPS-J may be preferably used.

Next, coagulant solution 20 will be described in detail. The coagulant will be described first. As for the coagulant, those generally used as industrial applications may be used if they are able to accelerate the coagulation of metal colloidal particles. Coagulants may be largely classified into inorganic coagulants, organic coagulants, and polymer coagulants. Inorganic coagulants include aluminum sulfate, aluminum chloride, polyaluminum chloride (PAC), calcium chloride, magnesium chloride, ferric chloride, polyferric sulphate, and the like. Organic coagulants include polyamine, diallyldimethyl ammonium chloride (DADMAC), melamine acid colloid, dicyandiamide, and the like. Polymer coagulants include anionic, nonionic, cationic, and amphoteric coagulants. In particular, the anionic polymer coagulants include carboxylic acid and sulfonic acid coagulants. As for cationic polymer coagulants, methacrylic ester and acrylic ester polymer coagulants may be cited.

Among inorganic coagulants, organic coagulants, and polymer coagulants, inorganic coagulants are preferably used because of ease of preparing a solution thereof and adjusting the concentration. In particular, a solution prepared by diluting polyaluminum chloride, magnesium chloride, or calcium chloride with a solvent is preferably used.

Preferably, the concentration of the solution is in the range from 0.1 to 30% for any type of solution, more preferably in the range from 1 to 8%, and further preferable in the range from 1 to 3%.

There is not any specific restriction on the solvent of the coagulant as long as it is different from the solvent of metal colloid solution 14 and has compatibility therewith. For example, water, organic solvents and the like may be cited as in the solvent of metal colloid solution 14. As for the organic solvents, various compounds as described in the solvent of metal colloid solution 14 may be used.

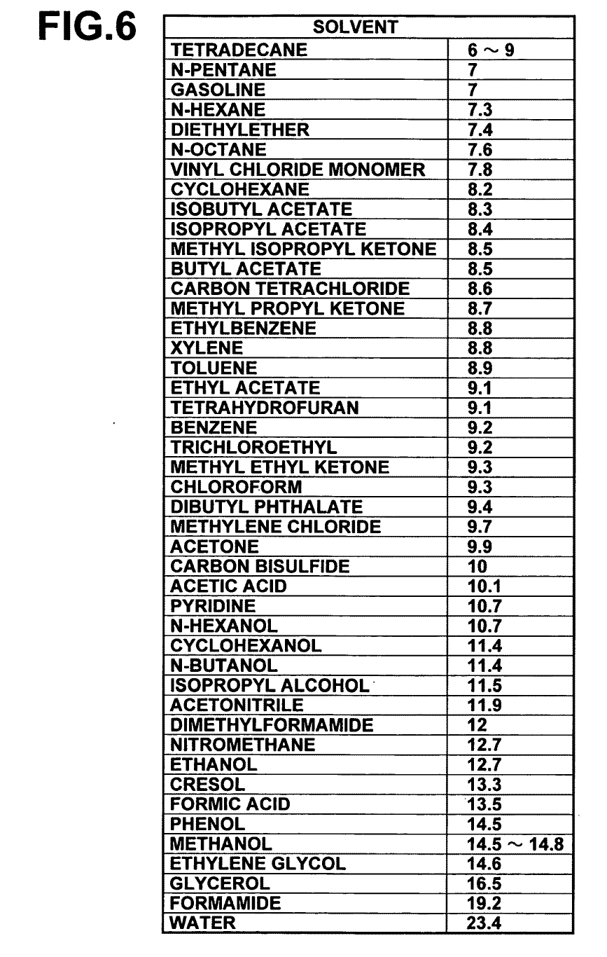

Preferably, the difference in SP (solubility parameter) value between the solvent of metal colloid solution 14 and solvent of coagulant 20 is in the range from 1 to 15 at room temperature, and more preferably in the range from 2 to 10. SP values of example solvents are shown in FIG. 6. With reference to the SP values shown in FIG. 6, the solvent of metal colloid solution 14 and the solvent of coagulant 20 may be selected such that the difference in SP value between them falls in the range from 1 to 15 and more preferably in the range from 2 to 10 at room temperature of 25° C. For example, when NPS-J, manufactured by Harima Chemicals, Inc., is used as metal colloid solution 14, the solvent used is tetradecane (SP value, 6 to 9), and an aqueous solution (solvent used is water with an SP value of 23.4) prepared by diluting Alphaine 83 (aluminum chloride), manufactured by Taimei Chemicals Co., Ltd., to a concentration of 2% with ion-exchange water may be used as coagulant solution 20.

As for the mixed solution usable for forming coagulant added reception layer 30 in the third embodiment, the reception layer forming solution added with polyaluminum chloride (PAC) as the coagulant may be used. An example of base material 10 having such coagulant added reception layer 30 formed there on is an inkjet receiver paper (Kassai, “Photofinishing” Value) manufactured by FUJIFILM Corporation.

Further, as for coagulant solution 20 for use in the electronic circuit board manufacturing method according to the fourth embodiment, a basic solution added with a coagulant, such as polyaluminum chloride (PAC), magnesium chloride, or calcium chloride described above may be used. In this case, coagulant solution 20 functions as a basic solution by applying coagulant solution 20 at the same time with reception layer forming solution 40 or in the middle of drying of reception layer forming solution 40 and before the reception layer exhibits decreasing drying. Therefore, the cross-linking effect of the reception layer may be onset simultaneously with the application of coagulant solution 20. In the fourth embodiment, coagulant solution 20 may be applied after the reception layer is formed, i.e., after reception layer forming solution 40 is dried.

Basically, the present invention is like that described above.

So far embodiments of the electronic circuit board manufacturing method of the present invention have been described in detail, but the present invention is not limited to these embodiments and it will be appreciated that various modifications and changes may be made without departing from the scope of the present invention as set forth in the appended claims.

### EXAMPLES

Electronic circuit boards were produced as Examples of the present invention and Examples were evaluated, the results of which will now be described.

### Examples 1, 2

For examples 1, 2, glass was used as base material 10. As coagulant solution 20, an aqueous solution of Alphaine 83 (aluminum chloride), manufactured by Taimei Chemicals Co., Ltd., diluted to a concentration of 2% with ion-exchange water was used. As the solvent of metal colloid solution 14, NPS-J, manufactured by Harima Chemicals, Inc., was used (for Example 1, the solvent used is tetradecane) and AGIN-W4A, manufactured by Sumitomo Electric Industries Ltd., was used (for Example 2).

Coagulant solution 20 was applied over a surface of base material 10 by a bar coating method, then the applied solution was dried at 70° C. for 5 minutes, and a conductive pattern was formed with metal colloid solution 14. Then, 6 days after the formation of the conductive pattern, the volume resistivity of the conductive pattern was measured using Loresta-GP manufactured by Mitsubishi Chemical Corporation. For each of Examples 3 to 6 to be described hereinafter, the volume resistivity was measured in the same manner as described above.

### Example 3

As base material 10 having reception layer 12 formed thereon, an inkjet receiver paper (Kassai, “Photofinishing” Value) manufactured by FUJIFILM Corporation was used. As coagulant solution 20, an aqueous solution of Alphaine 83 (aluminum chloride), manufactured by Taimei Chemicals Co., Ltd., diluted to a concentration of 2% with ion-exchange water was used. As the solvent of metal colloid solution 14, AGIN-W4A, manufactured by Sumitomo Electric Industries Ltd., was used.

### Example 4

As base material 10 having coagulant added reception layer formed thereon, an inkjet receiver paper (Kassai, “Photofinishing” Value) manufactured by FUJIFILM Corporation was used. As the solvent of metal colloid solution 14, AGIN-W4A, manufactured by Sumitomo Electric Industries Ltd., was used.

### Example 5

Base material having coagulant added reception layer 30 formed thereon was produced in the following manner.

### <Manufacture of “Liquid Non-Permeable Base Material>

50 parts of acacia LBKP and 50 parts of aspen LBKP were beaten to a Canadian freeness of 300 ml in a disk refiner to prepare a pulp slurry.

Then, with respect to the pulp slurry, 1.3% of a cationic starch (CAT0304L, manufactured by Japan NSC), 0.15% of an anionic polyacrylamide (Polyacron ST-13, manufactured by Seiko Chemicals, Co., Ltd.), 0.29% of an alkylketene dimer (Sizepine K, manufactured by Arakawa Chemical Industries, Ltd.), 0.29% of epoxidated amide behenate, and 0.32% of polyamide polyamine epichlorohydrin (Arafix 100, manufactured by Arakawa Chemical Industries, Ltd.) were added to the pulp slurry, and thereafter 0.12% of an antifoam agent was also added.

The above prepared pulp slurry is then made into paper using a Fourdrinier paper machine, and in a drying process in which the felt surface of the web is pressed against a drum dryer cylinder via a dryer canvas, the dryer canvas tension was adjusted to 1.6 kg/cm. After drying, the base paper is size pressed on both surfaces with polyvinyl alcohol (trade name:KL-118; manufactured by Kuraray Company Ltd.) coated at rate of 1 g/m², dried, and calendar processed. The basis weight of the sheeted base paper was 157 g/m², and a base paper (base material) having a thickness of 157 μm was obtained.

One surface of the obtained base paper was subjected to a corona discharge treatment, and a polyethylene having a density of 0.93 g/cm³ and having a 10 mass % of titanium oxide was extruded at 320° C. and coated thereon at a rate of 24 g/m² using a melt extruder.

Following this, also the other surface is subjected to a corona discharge treatment, and a polyethylene having a density of 0.93 g/cm³ and having a 10 mass % of titanium oxide was extruded at 320° C. and coated thereon at a rate of 24 g/m² using the melt extruder.

This provided a polyethylene resin coated paper, i.e., the base paper coated with the polyethylene (liquid non-permeable base material).

### <Preparation of Reception Layer Forming Solution>

Out of the composition list shown below, (1) gas phase process silica fine particles, (2) ion-exchange water, (3) Shallol DC902P, and (4) ZA-30 were mixed and dispersed by a liquid-liquid collision-type disperser (Ultimizer manufactured by Sugino Machine Ltd). Then, the dispersion solution obtained was heated to 45° C. for 20 hours. Thereafter, (5) boric acid, (6) polyvinyl alcohol solution, and (7) cationic-modified polyurethane were added to the dispersion solution at 30° C. to prepare reception layer forming solution 40. The mass ratio between the silica fine particles and water soluble resin (PB ratio=(1):(6)) was 4.9:1, pH of reception layer forming solution was 3.4 showing an acidity.

Composition of Reception Layer Forming Solution—

| | | |
|---|---|---|
| (1) | Gas phase process silica fine particles (inorganic fine | 8.9 parts |
| | particles) | |
| | (AEROSIL 300SF75, by Nippon Aerosil Co., Ltd) | |
| (2) | Ion-exchange water | 47.3 parts |
| (3) | Shallol DC902P (51.5% aqueous solution) | 0.78 parts |
| | (dispersant, nitrogen-containing organic cationic | |
| | polymer, by Dai-ichi Kogyo Seiyaku Co., Ltd) | |
| (4) | ZA-30 (50% aqueous solution) | 0.48 parts |
| | (Zirconyl acetate, by Daiichi Kigenso Kagaku Kogyo | |
| | Co., Ltd) | |
| (5) | Boric acid (7.5% aqueous solution) | 4.38 parts |
| (6) | Polyvinyl alcohol (water soluble resin) solution | 26.0 parts |

Composition of Polyvinyl Alcohol Solution—

| | | |
|---|---|---|
| | JM33 | 1.81 parts |
| | (polyvinyl alcohol (PVA), a saponification value 95.5%, | |
| | polimization degree 3300, by Japan VAM & POVAL | |
| | Co., Ltd) | |
| | HPC-SSL | 0.08 parts |
| | (water soluble cellulose, by Nippon Soda Co., Ltd) | |
| | Ion-exchange water | 23.5 parts |
| | Diethylene glycol monobutyl ether | 0.55 parts |
| | (Butycenol 20P, by Kyowa Hakko Kogyo Co., Ltd) | |
| | Emulgen 109P (surfactant, by Kao Corp) | 0.06 parts |
| (7) | Cationic-modified polyurethane | 1.8 parts |
| | (SUPERFLEX 650-5 (25% solution), by Dai-ichi Kogyo | |
| | Seiyaku Co., Ltd) | |

### <Formation of Coagulant Added Reception Layer>

After one surface of the liquid non-permeable base material obtained in the manner as described above was subjected to a corona discharge treatment, the reception layer forming solution obtained in the manner as described above was applied on the surface in a manner described below by an extrusion die coater to form a coated layer. More specifically, the reception layer forming solution was applied to base material 10 at a rate of 17.5 g/m².

The coated layer formed by the application described above was dried at 80° C. (with a wind velocity of 3 to 8 m/sec) by a hot-air dryer until the solid content density of the coated layer reaches 36%. The coated layer exhibited a constant drying rate during this period. Immediately thereafter, the coated layer was immersed in coagulant solution 20 having the composition below for 3 seconds to attach the coagulant solution by 13 g/m², which is then dried at 72° C. for 10 minutes (drying process), whereby coagulant added reception layer 30 was formed on one side of the liquid non-permeable support. This provided base material 10 having coagulant added reception layer 30 formed thereon.

### Composition of Coagulant Solution—

| | | |
|---|---|---|
| (1) | Alphaine 83 (Taimei Chemicals Co., Ltd) | 20 parts |
| (2) | Ammonium bicarbonate | 5 parts |
| | (first grade, by Kanto Kagaku Co. Inc) | |
| (3) | Ion-exchange water | 69 parts |
| (4) | Polyoxyethylene laurylether (surfactant) | 6 parts |

(Emulgen 109P, 10% Aqueous Solution, by Kao Corp, HLB Value 13.6) Also in Example 5, AGIN-W4A, manufactured by Sumitomo Electric Industries Ltd., was used as the solvent of metal colloid solution 14.

### Example 6

An inkjet recording medium was obtained by a similar manner to that of Example 5, except that magnesium chloride (5 parts) was used instead of Alphaine 83 in the second coating solution and the ion-exchange water was changed from 69 parts to 84 parts. Also in Example 6, AGIN-W4A, manufactured by Sumitomo Electric Industries Ltd., was used as the solvent of metal colloid solution 14.

### Comparative Examples 1, 2

In Comparative Examples 1, 2, conductive patterns were formed by a similar method to that of Examples 1, 2 except that coagulant solution 20 was not applied over the surface of base material 10 and using metal colloid solution 14 identical to that used in Examples 1, 2.

According to the measurement results, the volume resistivities of Example 1 and Example 2 of the present invention were 3.8E-5 and 4.4E-4 respectively. Also, Examples 3 to 6 showed favorable volume resistivities. In particular, the volume resistivity of Example 4 was 2.0E-5. In contrast, Comparative Examples 1, 2 showed infinite volume resistivity. The volume resistivity remained infinite after any standing time.

As described above, it has been found that once coagulant solution 20 is applied on base material according to the present invention, conductivity can be induced by allowing a conductive pattern at room temperature. Further, it has also been found that the use of base material 10 having coagulant added reception layer formed thereon may induce conductivity after allowing a conductivity pattern at room temperature.

What is claimed is:

1. An electronic circuit board manufacturing method, comprising:
a pattern forming step for forming a conductive pattern of an electronic circuit board by applying a metal colloid solution on a base material by an inkjet method; and
a coagulant application step for applying a coagulant solution at least on the conductive pattern by a deposition method.

2. The electronic circuit board manufacturing method of claim 1, wherein an application amount of the coagulant solution is greater than an application amount of the metal colloid solution.

3. The electronic circuit board manufacturing method of claim 1, wherein an application area of the coagulant solution is not greater than an application area of the metal colloid solution.

4. The electronic circuit board manufacturing method of claim 1, wherein a solvent of the coagulant solution has compatibility with a solvent of the metal colloid solution.

5. The electronic circuit board manufacturing method of claim 1, wherein the base material is a reception layer-equipped base material having a porous reception layer formed on a surface thereof.

6. An electronic circuit board manufacturing method, comprising, when forming a conductive pattern of an electronic circuit board by applying a metal colloid solution on a base material by an inkjet method:
a coagulant solution application step for applying a coagulant solution on the base material; and
a pattern forming step for forming the conductive pattern on the coagulant solution with the metal colloid solution.

7. The electronic circuit board manufacturing method of claim 6, wherein a solvent of the coagulant solution has compatibility with a solvent of the metal colloid solution.

8. The electronic circuit board manufacturing method of claim 6, wherein the base material is a reception layer-equipped base material having a porous reception layer formed on a surface thereof.

9. An electronic circuit board manufacturing method, comprising, when forming a conductive pattern of an electronic circuit board on a reception layer-equipped base material, which is a base material with a porous reception layer having a coagulant provided on a surface of the base material,
a pattern forming step for forming the conductive pattern by applying a metal colloid solution on the reception layer-equipped base material by an inkjet method.

10. The electronic circuit board manufacturing method of claim 9, wherein the reception layer-equipped base material is provided by a solution application step in which a mixed solution of a porous reception layer forming component and a coagulant is applied on the base material.

11. The electronic circuit board manufacturing method of claim 9, wherein the reception layer-equipped base material is provided by a reception layer forming coagulant solution application step in which a porous reception layer forming component solution and a coagulant solution are applied on the base material.

12. The electronic circuit board manufacturing method of claim 11, wherein the reception layer forming coagulant solution application step is a step comprising a reception layer forming solution application step for applying a reception layer forming solution having the porous reception layer forming component and a coagulant application step for applying the coagulant solution, which is incorporated in the reception layer forming solution application step.
